(19) United States
(12) Patent Application Publication
(10) Pub. No.: US 2022/0350126 A1
(43) Pub. Date: Nov. 3, 2022

(54) INVERTED MICROSCOPE APPARATUS

(71) Applicant: OLYMPUS CORPORATION, TOKYO (JP)

(72) Inventor: Yoshihiro SHIMADA, Tokyo (JP)

(73) Assignee: OLYMPUS CORPORATION, TOKYO (JP)

(21) Appl. No.: 17/730,154

(22) Filed: Apr. 26, 2022

(30) Foreign Application Priority Data
Apr. 28, 2021 (JP) 2021-075532

(51) Int. Cl. G02B 21/33; G02B 21/00; G02B 21/26

(52) U.S. Cl. CPC G02B 21/33; G02B 21/0088; G02B 21/26

(57) ABSTRACT

An inverted microscope apparatus includes an immersion objective, an electric stage that moves at least in a direction orthogonal to an optical axis of the immersion objective, and a removal mechanism that removes an immersion liquid adhering to a bottom surface of a container placed on the electric stage. The removal mechanism is configured to scan the bottom surface using movement of the electric stage.

### CROSS REFERENCE TO RELATED APPLICATIONS

This application is based upon and claims the benefit of priority from prior Japanese Patent Application No. 2021-075532, filed Apr. 28, 2021, the entire contents of which are incorporated herein by this reference.

### TECHNICAL FIELD

The disclosure herein relates to an inverted microscope apparatus.

### BACKGROUND

Currently, studies using cell aggregates such as spheroids and organoids obtained by three-dimensionally culturing cells have attracted attention. In recent years, spheroids and organoids are imaged using a microscope apparatus, and the acquired microscopic image data is screened for drug discovery using an image analysis technique to evaluate drug efficacy.

The deep imaging and the Z series imaging (also referred to as “Z stack imaging”) of the observation target as described above are generally performed by an automated inverted microscope apparatus with the observation target contained in a container together with a culture solution and a transparency solution. Such a technique is described in, for example, JP 2008-170867 A.

### SUMMARY

An inverted microscope apparatus according to an aspect of the present invention includes an immersion objective, an electric stage that moves at least in a direction orthogonal to an optical axis of the immersion objective, and a removal mechanism that removes an immersion liquid adhering to a bottom surface of a container placed on the electric stage. The removal mechanism is configured to scan the bottom surface using movement of the electric stage.

### BRIEF DESCRIPTION OF DRAWINGS

The present invention will be more apparent from the following detailed description when the accompanying drawings are referenced.

FIG. 1 is a diagram illustrating a configuration of an observation apparatus according to a first embodiment;

FIG. 2 is a diagram illustrating a configuration of a well plate;

FIG. 3 is a diagram for explaining a configuration of a wiper;

FIG. 4 is another diagram for explaining the configuration of the wiper;

FIG. 5 is a diagram for explaining an operation of the observation apparatus;

FIG. 6 is another diagram for explaining the operation of the observation apparatus;

FIG. 7 is yet another diagram for explaining the operation of the observation apparatus;

FIG. 8 is still another diagram for explaining the operation of the observation apparatus;

FIG. 9 is still another diagram for explaining the operation of the observation apparatus;

FIG. 10 is still another diagram for explaining the operation of the observation apparatus;

FIG. 11 is still another diagram for explaining the operation of the observation apparatus;

FIG. 12 is still another diagram for explaining the operation of the observation apparatus;

FIG. 13 is still another diagram for explaining the operation of the observation apparatus;

FIG. 14 is still another diagram for explaining the operation of the observation apparatus;

FIG. 15 is still another diagram for explaining the operation of the observation apparatus;

FIG. 16 is still another diagram for explaining the operation of the observation apparatus;

FIG. 17 is still another diagram for explaining the operation of the observation apparatus;

FIG. 18 is still another diagram for explaining the operation of the observation apparatus;

FIG. 19 is a diagram illustrating a configuration of an observation apparatus according to a second embodiment;

FIG. 20 is a diagram for explaining an operation of the observation apparatus;

FIG. 21 is another diagram for explaining the operation of the observation apparatus;

FIG. 22 is yet another diagram for explaining the operation of the observation apparatus;

FIG. 23 is still another diagram for explaining the operation of the observation apparatus;

FIG. 24 is still another diagram for explaining the operation of the observation apparatus;

FIG. 25 is still another diagram for explaining the operation of the observation apparatus;

FIG. 26 is still another diagram for explaining the operation of the observation apparatus;

FIG. 27 is still another diagram for explaining the operation of the observation apparatus;

FIG. 28 is a diagram illustrating a configuration of an observation apparatus according to a third embodiment;

FIG. 29 is a diagram illustrating a configuration of an observation apparatus according to a fourth embodiment;

FIG. 30 is a diagram for explaining an operation of the observation apparatus;

FIG. 31 is another diagram for explaining the operation of the observation apparatus;

FIG. 32 is yet another diagram for explaining the operation of the observation apparatus;

FIG. 33 is still another diagram for explaining the operation of the observation apparatus;

FIG. 34 is a diagram illustrating a configuration of an observation apparatus according to a fourth embodiment;

FIG. 35 is a diagram for explaining an operation of the observation apparatus;

FIG. 36 is another diagram for explaining the operation of the observation apparatus; and

FIG. 37 is yet another diagram for explaining the operation of the observation apparatus.

### DESCRIPTION

The observation targets described above have a size of about 100 μm to 500 μm, and image quality is likely to be degraded due to spherical aberration in deep imaging for imaging the inside of the observation targets. Therefore, it is strongly desired to use an immersion objective capable of suppressing a refractive index mismatch, which is the main cause of the spherical aberration in deep imaging. In particular, in order to enable deep imaging in a wide range in a depth direction (an optical axis direction), it is desirable to use an immersion objective with a long working distance.

On the other hand, the use of the immersion objective creates a new challenge of treating an immersion liquid. In an inverted microscope apparatus, since the immersion liquid is supplied between an objective and a container, it is necessary to remove the immersion liquid adhering to each of the objective and the bottom surface of the container after imaging is completed. Since the container is carried to the outside of the microscope apparatus after imaging is completed, if the immersion liquid is not appropriately treated, the immersion liquid adhering to the bottom surface of the container may fall as droplets during the movement of the container, and contaminate a floor, a desk, and the like. In particular, in a case where the immersion objective with a long working distance is used, a large amount of immersion liquid remains on the bottom surface of the container, so that there is a high possibility that droplets fall during the movement of the container.

In view of the above circumstances, embodiments of the present invention will be described below.

### First Embodiment

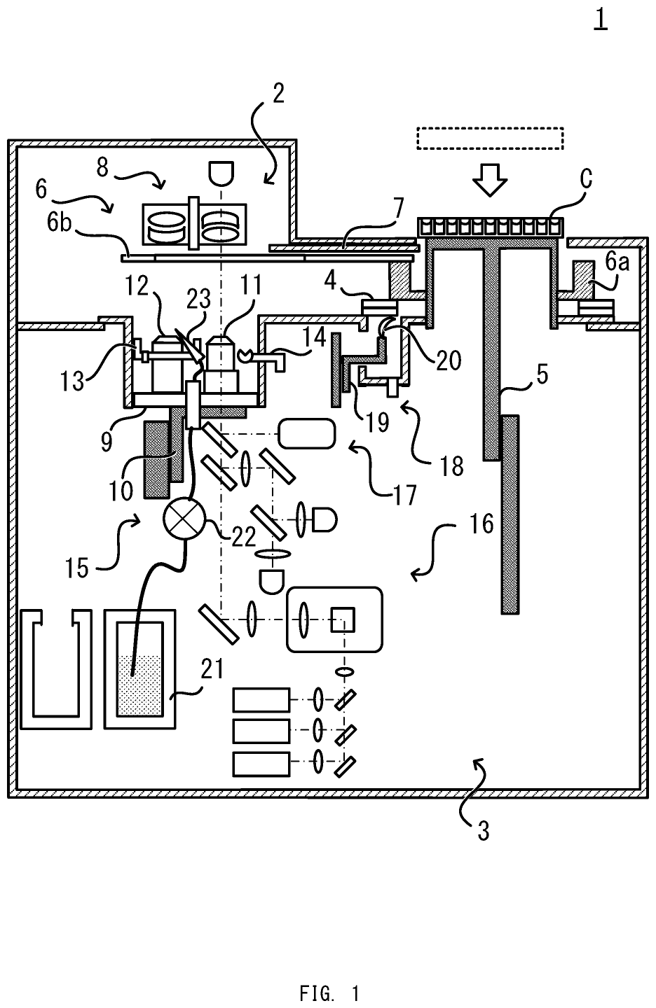

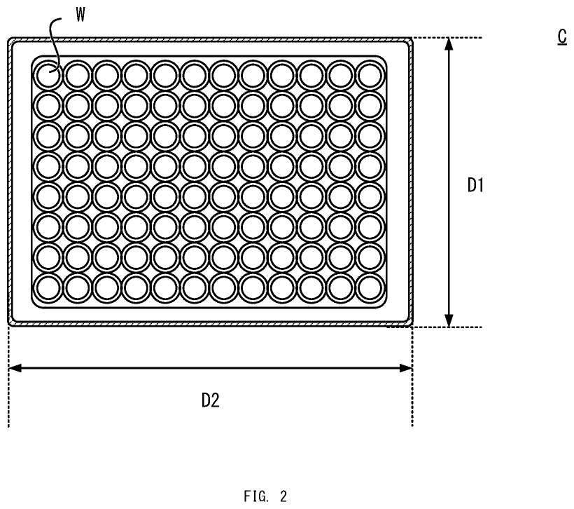

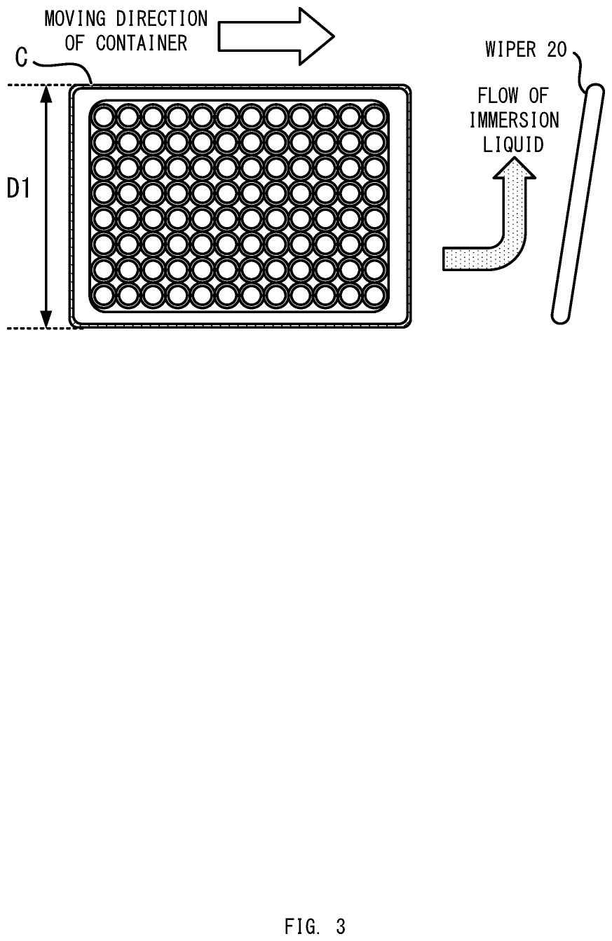

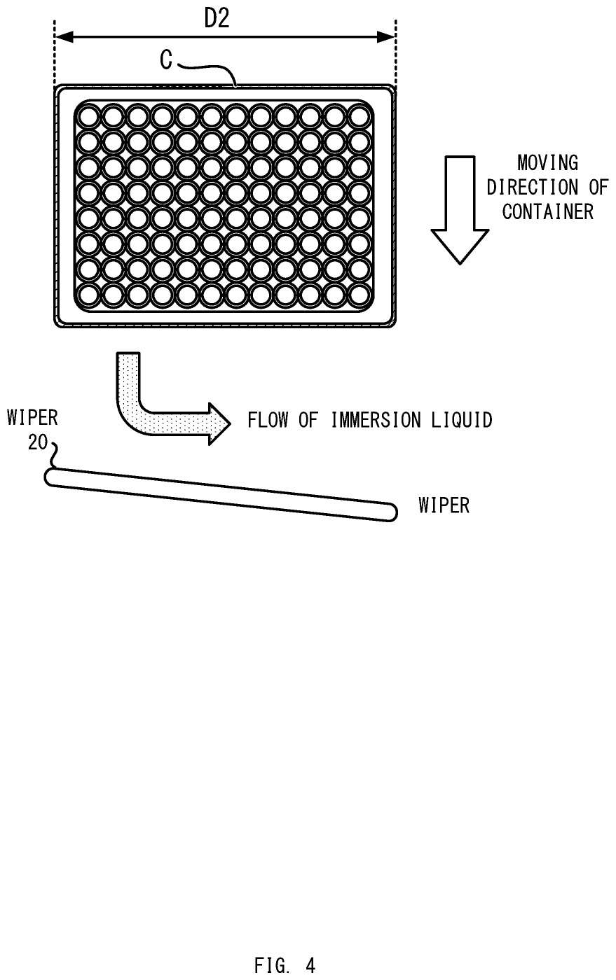

FIG. 1 is a diagram illustrating a configuration of an observation apparatus 1 according to this embodiment. FIG. 2 is a diagram illustrating a configuration of a well plate C. FIGS. 3 and 4 are diagrams for explaining a configuration of a wiper 20. Hereinafter, the configuration of the observation apparatus 1 will be described with reference to FIGS. 1 to 4.

The observation apparatus 1 is an inverted microscope apparatus, and is an automatic microscope apparatus that automatically performs operations from conveyance of a container containing a sample to imaging of the sample contained in the container. In the observation apparatus 1, as illustrated in FIG. 1, optical structures such as an illumination system and a detection system of the microscope are housed in a housing of the observation apparatus 1 and blocked from an external environment. As a result, the sample can be imaged in a constant environment regardless of the illumination environment in the room in which the observation apparatus 1 is installed. The type of images of the sample acquired by the observation apparatus 1 is not particularly limited, and includes, for example, a fluorescence image, a bright field image, and the like.

The type of the container handled by the observation apparatus 1 is not particularly limited, and for example, the well plate C illustrated in FIG. 2 can be used. The well plate is also referred to as a microplate. The size (longitudinal and transverse widths D1 and D2) of the well plate C is defined by the standards, and is constant regardless of the number of wells W provided in the well plate C. Accordingly, it is only required to design elements (the wiper 20, a roll paper 26, and a nozzle 36) to be designed depending on the size of a container to be described later on the basis of the standardized size of the well plate C. Note that the container handled by the observation apparatus 1 may be, for example, a container of a type different from the well plate C, such as a dish or a flask.

The housing of the observation apparatus 1 includes an upper structure 2 and a lower structure 3. The well plate C containing the sample moves in the upper structure 2. The upper structure 2 functions as a heat retaining structure for maintaining the environment of the sample, and includes an XY stage 4, an incubator 6, a transmissive illumination system 8, an objective (an objective 11, an objective 12, and the like), and the like. On the other hand, the lower structure 3 includes the main configuration of a multiphoton excitation microscope 16 except for the objective and the transmissive illumination system 8. The lower structure 3 further includes a supply device 15 that supplies an immersion liquid and a removal device 18 that removes the immersion liquid adhering to the bottom surface of the well plate C. An elevator 5, a revolver 9 and a focusing unit 10 function as a part of the boundary between the upper structure 2 and the lower structure 3.

As illustrated in FIG. 1, the well plate C containing the sample is disposed on the upper surface of the elevator 5 exposed by sliding of an open and close door 7. Hereinafter, the position of the well plate C when placed on the upper surface of the elevator 5 is referred to as “delivery position” in the meaning of a position for delivering the well plate C to the observation apparatus 1. The operation of disposing the well plate C on the delivery position may be manually performed by a user, or may be automated by an electric mechanism (not illustrated) such as a robot hand.

The well plate C placed on the delivery position is carried to an observation position on the optical axis of an objective by an electric stage. Specifically, the well plate C is carried in a vertical direction into the housing by the elevator 5, and then carried in a horizontal direction to the observation position by the XY stage 4. The electric stage of the observation apparatus 1 includes the elevator 5 that moves in the vertical direction and the XY stage 4 that moves in the horizontal direction. In addition, the vertical direction is a direction parallel to the optical axis of an immersion objective to be described later, and the horizontal direction is a direction orthogonal to the optical axis of the immersion objective to be described later.

After imaging at the observation position is completed, the well plate C is carried to the delivery position by the electric stage. Specifically, the well plate C is carried in the horizontal direction to below the delivery position by the XY stage 4 and then carried in the vertical direction to the delivery position by the elevator 5. As described above, in the observation apparatus 1, the movement of the well plate C between the delivery position and the observation position is automatically performed by the electric stage.

The incubator 6 provided in the upper structure 2 is a stage top incubator. The incubator 6 includes a support portion 6a that supports the well plate C and a lid portion 6b that slides relative to the support portion 6a.

The support portion 6a is fixed on the XY stage 4, whereas the lid portion 6b is fixed at a predetermined position corresponding to the observation position in the upper structure 2. With such a configuration, a structure in which the lid portion 6b is opened and closed with respect to the support portion 6a by the movement of the XY stage 4 is implemented. More specifically, when the XY stage 4 carries the well plate C to the observation position, the support portion 6a fixed to the XY stage 4 moves to the lower side of the lid portion 6b together with the XY stage 4. In this state, the upper opening of the support portion 6a is covered by the lid portion 6b, and the lower opening of the support portion 6a is covered by the well plate C, so that a sealed space including the well plate C is formed in the incubator 6. Therefore, in a state where the well plate C is at the observation position, the observation apparatus 1 can image the sample in each well of the well plate C under the environment managed by the incubator 6.

In the observation apparatus 1, the temperature environment can be controlled by the incubator 6. A transparent heater film is deposited on the lower surface of the lid portion 6b. As a temperature controller (not illustrated) energizes the heater film provided on the lid portion 6b, the internal temperature of the incubator 6 in a state where the lid portion 6b is closed can be controlled. Most of the lid portion 6b is made of glass that transmits light. As a result, the observation apparatus 1 can support both observation using transmissive illumination (for example, imaging using the transmissive illumination system 8) and observation using epi-illumination (for example, imaging using the multiphoton excitation microscope 16). In addition, as the heater film is configured to be transparent, it is possible to appropriately control the temperature environment while avoiding adverse effects on observation.

In the observation apparatus 1, the humidity environment can also be controlled by the incubator 6. The support portion 6a has a structure (not illustrated) that stores water. By storing water in the support portion 6a, sufficient humidity can be given to the inside of the incubator 6 in a state where the lid portion 6b is closed.

A plurality of objectives are attached to the revolver 9. The objectives desirably include the dry system objective 11 with a low magnification used in macro observation, and the objective 12 with a magnification higher than that of the objective 11. Note that although FIG. 1 illustrates a state where two objectives are attached to the revolver 9, three or more objectives may be attached to the revolver 9. In addition to the objective 11 and the objective 12, an immersion objective with a higher magnification, for example, a magnification of 25 times may be attached to the revolver 9.

The objective 11 may have, for example, a reduction magnification, that is, a magnification of less than 1 time, and the observation apparatus 1 may image the entire well plate C with a small number of times of imaging by macro observation using the objective 11. Note that the macro observation is performed using the transmissive illumination system 8.

The objective 12 is an immersion objective, and is a water immersion objective that has an enlargement magnification, for example, a magnification of 10 times and uses water as an immersion liquid. Note that the objective 12 may be an oil immersion objective. Since the objective 12 allows satisfactory observation of the deep portion of the sample while the refractive index mismatch is suppressed, the objective 12 is used for imaging using the multiphoton excitation microscope 16. In addition, the objective 12, which is an immersion objective, has a high numerical aperture, and can efficiently take light from the sample. Therefore, the use of the objective 12 in imaging using the multiphoton excitation microscope 16 is desirable not only in terms of suppression of spherical aberration but also in terms of simultaneously achieving high resolution and an improvement in throughput due to the shortened exposure time of a camera.

Note that, although the configuration of the multiphoton excitation microscope 16 is not described in detail, the epi-illumination system of the multiphoton excitation microscope 16 includes, for example, an ultrashort pulse laser that emits laser light of a plurality of different wavelengths and a scanner that scans a sample with laser light. In addition, the detection system of the multiphoton excitation microscope 16 includes detectors of two or more channels that detect fluorescence generated from the sample by irradiation with laser light. Further, the multiphoton excitation microscope 16 includes an autofocus unit 17, and the autofocus unit 17 detects the bottom surface of the well plate C as a reference in the depth direction (the z direction).

An immersion liquid is supplied to the objective 12 by the supply device 15. Specifically, the immersion liquid (water) in a water supply bottle 21 is sucked by a pump 22, passes through a hollow rotating shaft of the revolver 9, and is discharged from a nozzle 23 provided in an adapter 13 attached to the objective 12 toward the distal end of the objective 12. In the observation apparatus 1, the supply device 15 is operated in a state where the objective 12 is brought close to the bottom surface of the well plate C to a distance corresponding to the working distance of the objective 12, so that the space between the bottom surface of the well plate C and the objective 12 is filled with the immersion liquid.

The immersion liquid flowing down from the distal end of the objective 12 is discharged through a pipe provided in the adapter 13. More specifically, the immersion liquid flowing down from the distal end of the objective 12 falls from the pipe provided in the adapter 13 to a receiving portion 14, and is collected in a drain bottle through a tube (not illustrated) connected to the receiving portion 14.

After imaging at the observation position is completed, the immersion liquid remaining on the bottom surface of the well plate C is removed by the removal device 18. The removal device 18 scans the bottom surface of the well plate C using the movement of the electric stage when the electric stage carries the well plate C from the observation position to the delivery position after imaging is completed. In this way, the immersion liquid adhering to the bottom surface of the well plate C is removed. In other words, the removal device 18 is a device that removes the immersion liquid adhering to the bottom surface of the well plate C placed on the XY stage 4, and is configured to scan the bottom surface of the well plate C using the movement of the XY stage 4.

The removal device 18 includes an elevator 19 and the wiper 20. The elevator 19 raises and lowers the wiper 20 to an interference position where the wiper interferes with the well plate C moving in the horizontal direction by the XY stage 4 and a retracted position where the wiper does not interfere with the well plate C. That is, the elevator 19 is an example of a moving device that moves the wiper 20.

More specifically, the elevator 19 maintains the wiper 20 at the interference position during a period in which the XY stage 4 moves the well plate C from the observation position to the delivery position and at least the well plate C passes through the interference position. On the other hand, during a period in which the XY stage 4 moves the well plate C from the delivery position to the observation position, the wiper 20 is maintained at the retracted position.

Note that the height of the bottom surface of the well plate C varies depending on the type and manufacturer of the well plate C, and as a result, the interference position also varies depending on the well plate C. Accordingly, it is desirable that the elevator 19 specifies the interference position on the basis of the information of the well plate C input to the observation apparatus 1 by the user before the start of the observation, and appropriately raises and lowers the wiper 20 to the retracted position and the specified interference position. In addition, the observation apparatus 1 may acquire the information of the well plate C on the basis of the identification information attached to the well plate C, and the elevator 19 may specify the interference position on the basis of the information of the well plate C acquired from the identification information.

The wiper 20 is an example of an interference member that interferes with the immersion liquid. The wiper 20 interferes with the immersion liquid adhering to the bottom surface of the well plate C during the period in which the XY stage 4 moves the well plate C from the observation position to the delivery position. The wiper 20 is lifted up to the interference position by the elevator 19 so as to block the movement of the immersion liquid moving together with the XY stage 4 at the interference position between the observation position and the delivery position. As a result, during the period in which the XY stage 4 moves the well plate C from the observation position to the delivery position, the immersion liquid adhering to the bottom surface of the well plate C is wiped by the wiper 20 and falls from the bottom surface, so that the immersion liquid is separated from the bottom surface.

The wiper 20 is made of, for example, an elastic member such as silicone rubber, and is desirably pressed against the bottom surface of the well plate C with an appropriate force. As a result, the wiper 20 comes into contact with the well plate C without any gap between the well plate C and the wiper 20. The immersion liquid adhering to the bottom surface of the well plate C can thus be securely wiped from the bottom surface and dropped from the bottom surface. In addition, the surface of the wiper 20 in contact with the well plate C is desirably formed of a curved surface. As the wiper 20 is appropriately deformed based on the pressure, it is possible to prevent an excessive pressure from being applied to the well plate C by the wiper 20.

The wiper 20 is only required to interfere with the immersion liquid adhering to the bottom surface of the well plate C and remove the immersion liquid to such an extent that droplets do not fall any further from the bottom surface. Accordingly, the wiper 20 does not necessarily have to contact the well plate C, and there may be a slight gap between the bottom surface of the well plate C and the wiper 20.

The wiper 20 desirably has a width based on the size of the well plate C. More desirably, the wiper 20 has a width corresponding to the width of the well plate C in a direction orthogonal to the direction in which the well plate C is moved by the XY stage 4. For example, in a case where the well plate C moves along the longitudinal direction as illustrated in FIG. 3, the wiper 20 desirably has a width corresponding to the width D1 of the well plate C in the lateral direction. Furthermore, in a case where the well plate C moves along the lateral direction as illustrated in FIG. 4, the wiper 20 desirably has a width corresponding to the width D2 of the well plate C in the lateral direction. As a result, the entire bottom surface of the well plate C can be scanned while an excessive increase in the size of the wiper 20 is avoided. Therefore, the immersion liquid can be efficiently removed from the bottom surface of the well plate C.

As illustrated in FIGS. 3 and 4, the wiper 20 is desirably disposed to be inclined with respect to the moving direction of the XY stage 4. As the wiper 20 is inclined, it is possible to form a predetermined flow of the immersion liquid removed from the bottom surface of the well plate C by the wiper 20. As a result, it is possible to guide the immersion liquid to a desired position and efficiently collect the immersion liquid.

That is, the wiper 20 desirably has a width based on the size of the well plate C, but the width direction of the wiper 20 and the moving direction of the XY stage 4 are not necessarily orthogonal to each other. The removal device 18 is only required to scan the bottom surface of the well plate C with the wiper 20 using the movement of the XY stage 4 in a direction orthogonal to the optical axis of the objective 12 and intersecting the width direction of the wiper 20.

By using the removal device 18, the observation apparatus 1 can remove the immersion liquid adhering to the bottom surface of the well plate C to such an extent that droplets do not fall any further using the conventionally performed operation of moving the well plate C from the observation position to the delivery position. As a result, according to the observation apparatus 1, since the immersion liquid is sufficiently removed from the bottom surface before reaching the delivery position, it is possible to prevent the immersion liquid from falling from the bottom surface when the well plate C is carried from the delivery position to the outside of the observation apparatus 1. In addition, when the well plate C is taken out at the delivery position, there is no concern that the immersion liquid falls to contaminate a floor and a desk. Furthermore, the observation apparatus 1 can remove the immersion liquid on the existing route without changing the conveyance route of the well plate C. As a result, it is also possible to maintain a high throughput of the observation apparatus 1 achieved by the optimized existing route. Therefore, according to the observation apparatus 1, it is possible to remove the immersion liquid without sacrificing the throughput and to reduce the burden on the user required for cleaning and the like.

Furthermore, in the observation apparatus 1, the removal device 18 does not need a structure that moves the wiper 20 in the horizontal direction by scanning the bottom surface using the movement of the XY stage 4. For this reason, the removal device 18 can be made relatively compact, and it is possible to avoid an increase in size of the observation apparatus 1 due to the addition of the function of removing the immersion liquid.

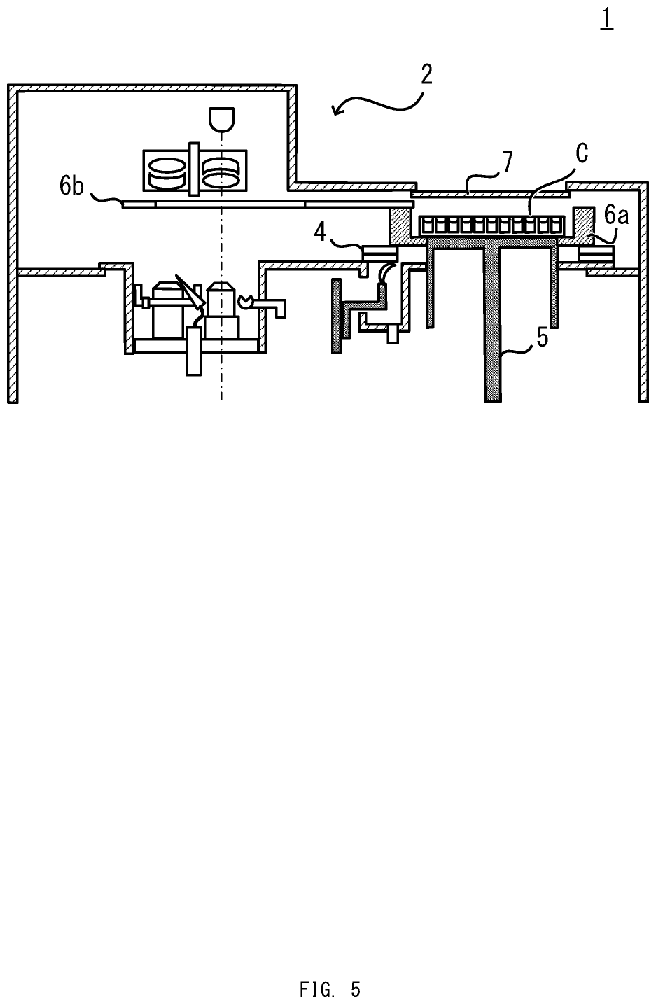

FIGS. 5 to 18 are diagrams for explaining an operation of the observation apparatus 1. Hereinafter, the operation of the observation apparatus 1 will be described in detail with reference to FIGS. 5 to 18.

As illustrated in FIG. 1, when the well plate C is disposed at the delivery position on the elevator 5, the elevator 5 starts to be lowered in the observation apparatus 1. As illustrated in FIG. 5, the well plate C placed on the elevator 5 is lowered together with the elevator 5 into the observation apparatus 1 until the bottom surface of the well plate C reaches the support portion 6a. For example, the open and close door 7 may be automatically closed at the timing when the bottom surface of the well plate C reaches the support portion 6a.

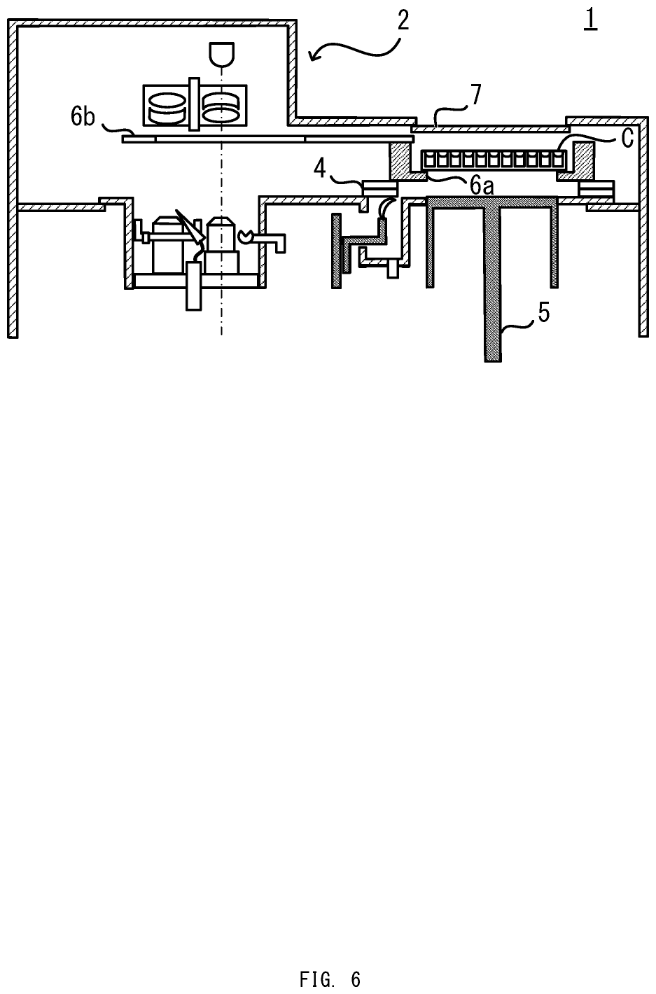

When the elevator 5 is further lowered from the state illustrated in FIG. 5, only the elevator 5 continues to be lowered, and the well plate C supported by the support portion 6a remains on the support portion 6a. The elevator 5 is lowered to a position where the XY stage 4 does not interfere with the elevator 5 when moving in the horizontal direction, and then stops. Specifically, as illustrated in FIG. 6, the elevator 5 is lowered to a position where the elevator 5 forms the boundary surface between the upper structure 2 and the lower structure 3. As a result, it is possible to suppress the flow of heat caused by the temperature difference generated between the upper structure 2 in which temperature control is executed and the lower structure 3 in which temperature control is not executed. Therefore, it is possible to suppress the occurrence of a temperature difference between the upper portion and the bottom portion of the well plate C.

Note that the well plate C whose bottom surface reaches the support portion 6a and is supported by the support portion 6a is then firmly held by the support portion 6a. The holding structure provided in the support portion 6a is not particularly limited, but the well plate C may be held by, for example, a contact mechanism that has an elastic force and is provided in the support portion 6a. The support portion 6a may sandwich the well plate C in the horizontal direction or may sandwich the well plate C in the vertical direction by the contact mechanism.

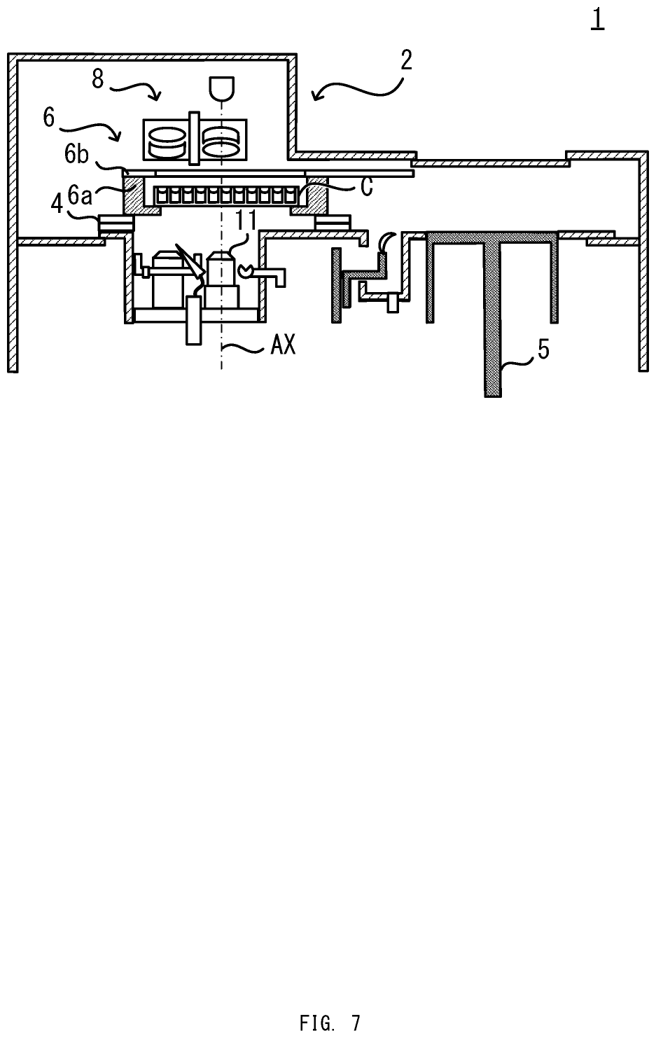

After the lowering of the elevator 5, the XY stage 4 moves in the horizontal direction, so that the well plate C is carried to the observation position on an optical axis AX as illustrated in FIG. 7. At this time, the support portion 6a is fitted into and fixed to a click mechanism provided on the lid portion 6b.

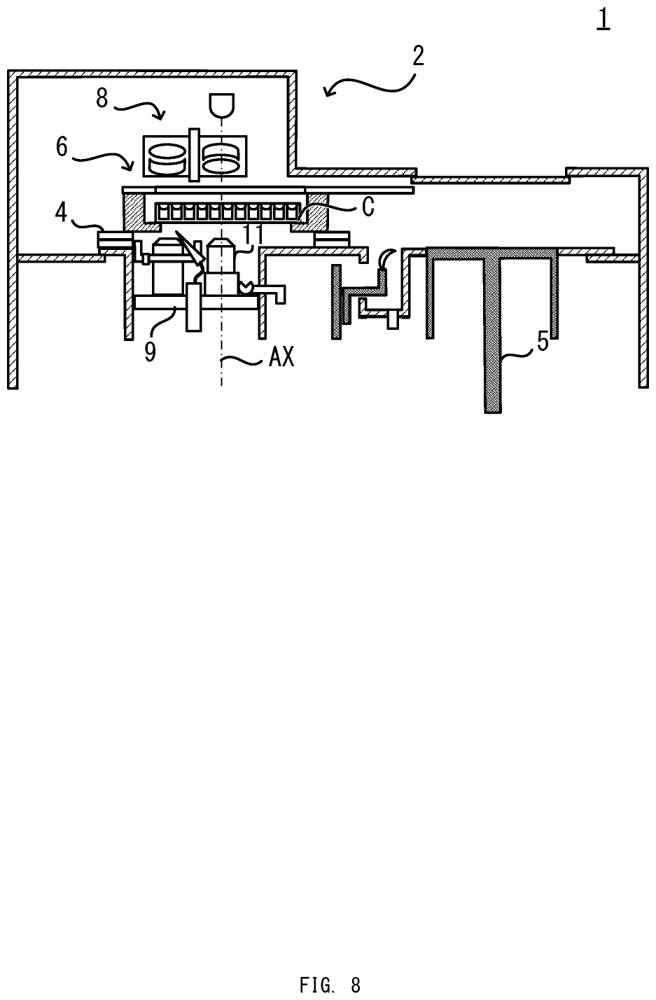

When the well plate C is carried to the observation position, the observation apparatus 1 first performs macro observation using the objective 11. At this time, as illustrated in FIG. 8, focusing is performed by moving the objective 11 in the direction of the optical axis AX together with the revolver 9 by the focusing unit 10 (see FIG. 1).

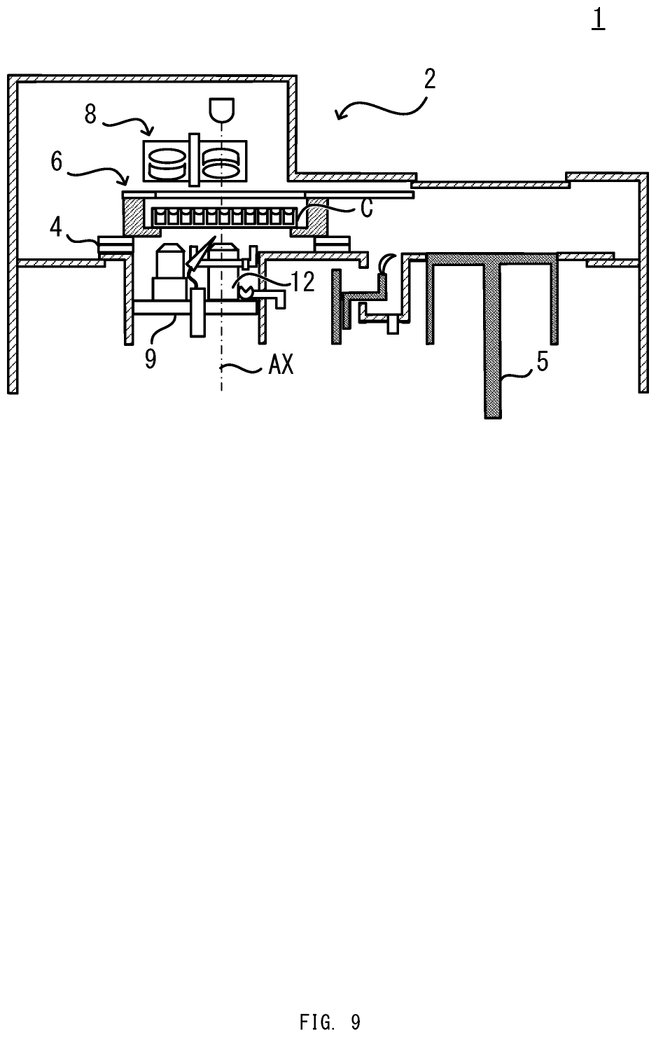

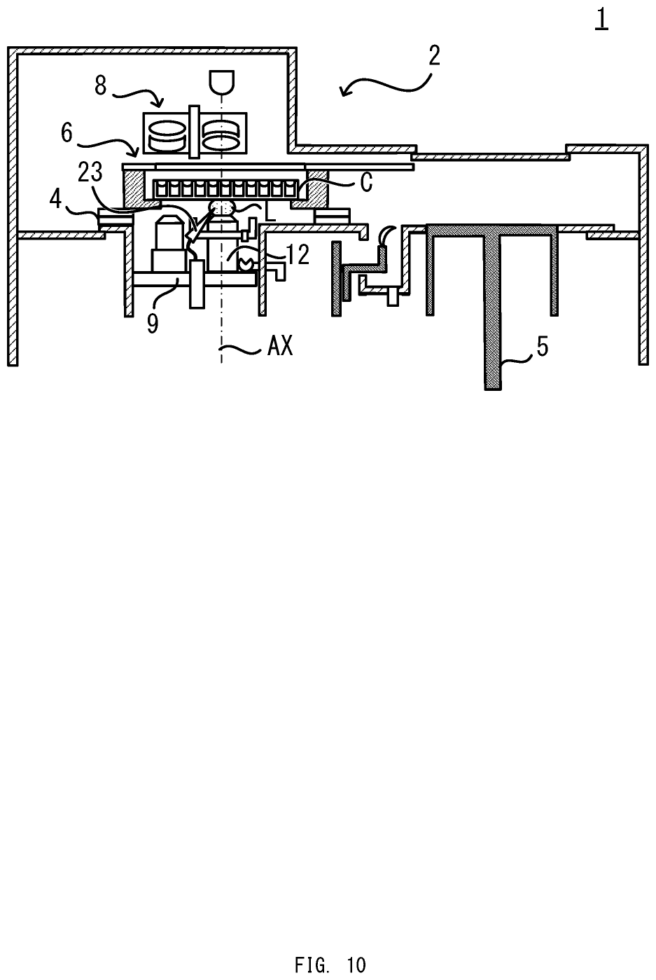

When the well or sample to be observed in the well plate C is checked by macro observation, the XY stage 4 is slightly moved to position the well or sample to be observed on the optical axis AX. Furthermore, the revolver 9 is rotated to dispose the objective 12 on the optical axis AX as illustrated in FIG. 9. Thereafter, as illustrated in FIG. 10, an immersion liquid L (water) is discharged from the nozzle 23 to fill the space between the objective 12 and the bottom surface of the well plate C with the immersion liquid L, and micro observation is performed. Note that the micro observation may be repeatedly performed while the wells to be observed are changed using the movement of the XY stage 4.

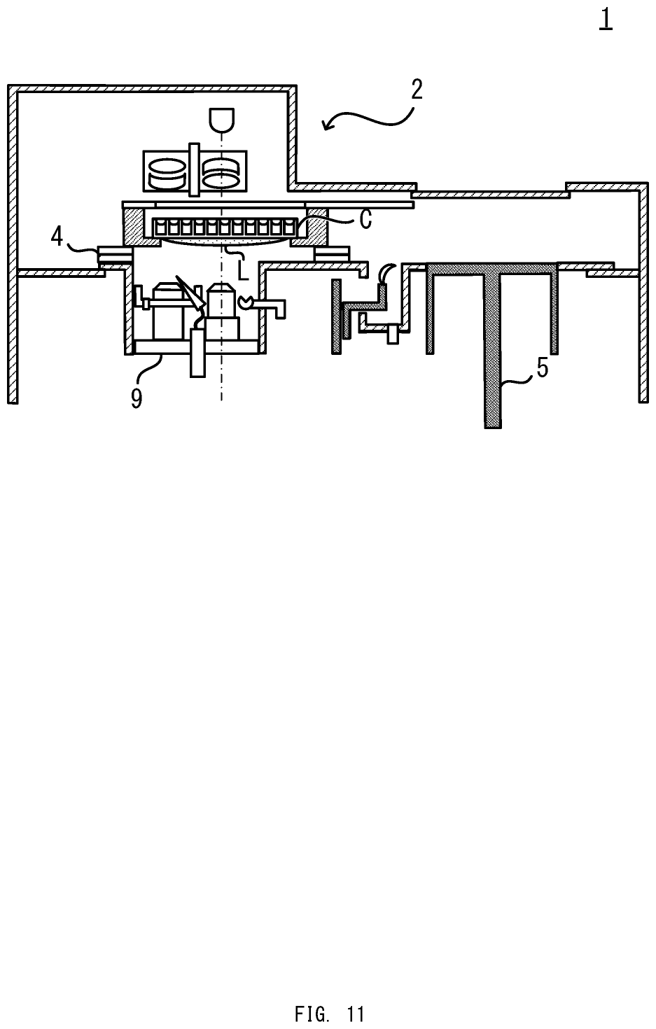

When the micro observation is completed, first, as illustrated in FIG. 11, the objective is moved in a direction away from the bottom surface of the well plate C by the focusing unit 10 (see FIG. 1) and is retracted. At this time, the revolver 9 may be further rotated to dispose an objective for macro observation on the optical axis AX.

Note that when the objective retracts, a part of the immersion liquid L between the objective and the well plate C flows down to the side of the objective. The immersion liquid L flowing down to the side of the objective is discharged through the pipe of the adapter 13 and the receiving portion 14. As illustrated in FIG. 11, the remaining immersion liquid L remains adhered to the bottom surface of the well plate C. Note that the amount of the immersion liquid L adhering to the bottom surface of the well plate C tends to increase as the number of wells to be observed in the micro observation increases.

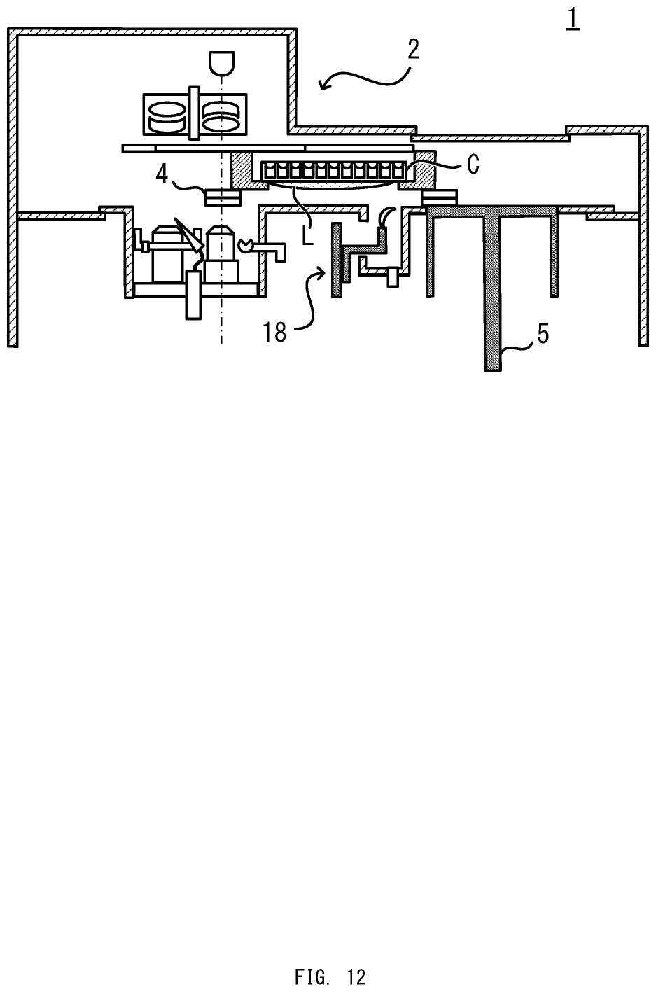

When the retraction of the objective is completed, the XY stage 4 starts to move toward the elevator 5, and temporarily stops when the well plate C reaches the position above the removal device 18 as illustrated in FIG. 12.

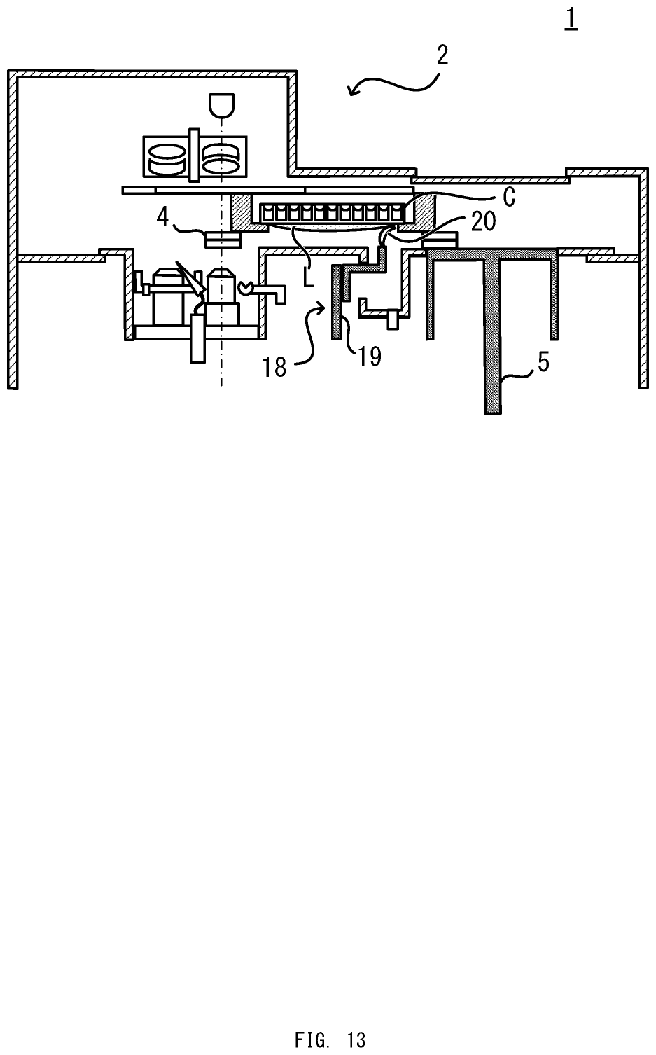

When the XY stage 4 stops, as illustrated in FIG. 13, the elevator 19 lifts the wiper 20 to an interference position where the wiper 20 is in contact with the bottom surface of the well plate C.

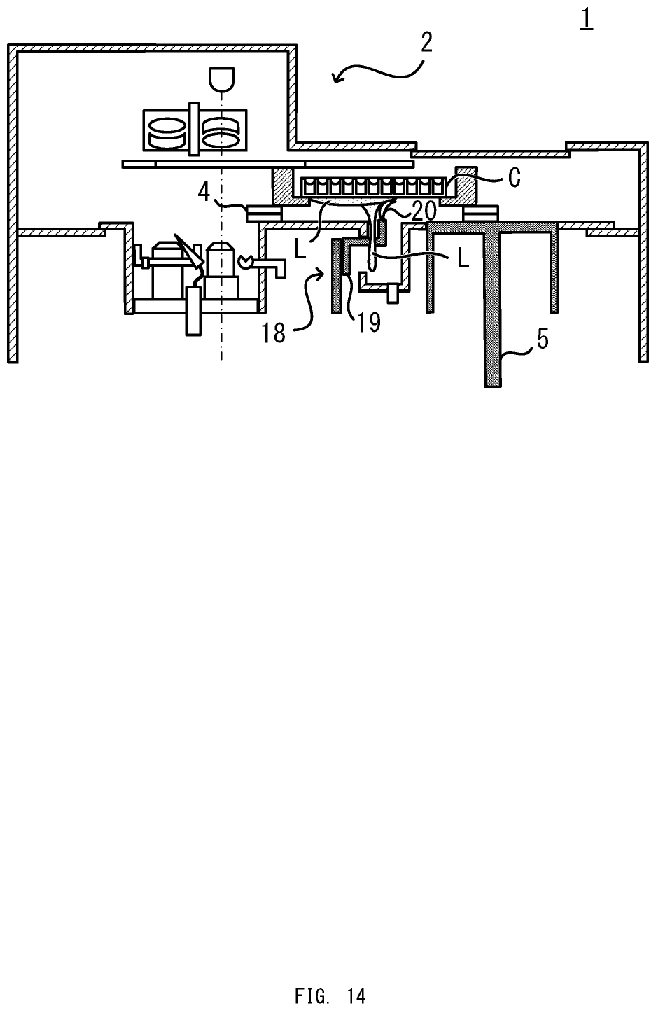

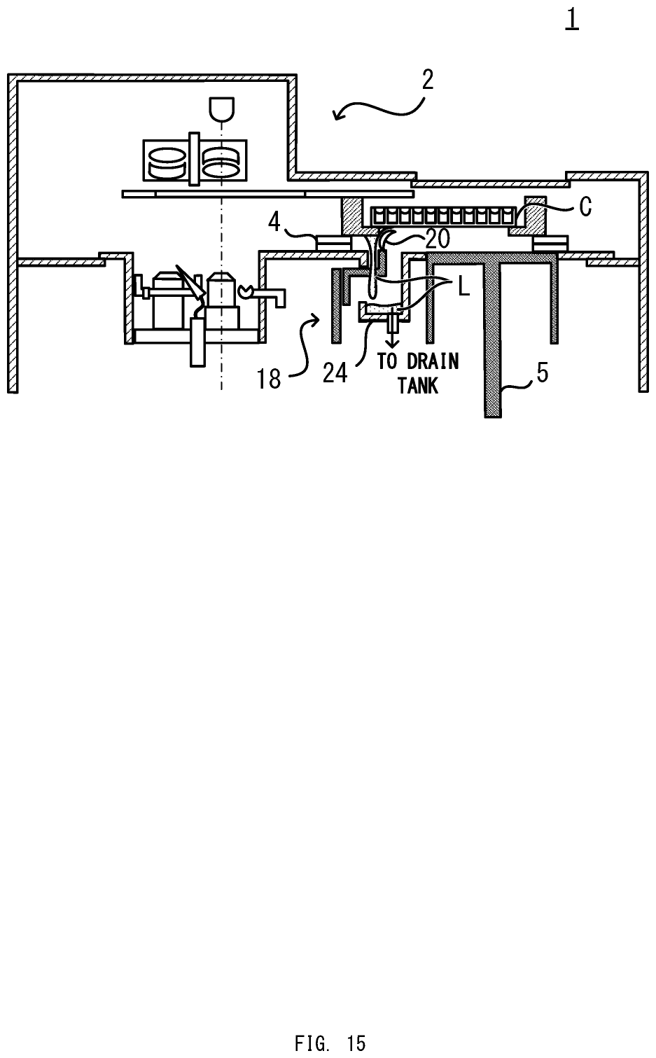

When the wiper 20 is disposed at the interference position, the XY stage 4 starts to move again in the horizontal direction toward the elevator 5. As the XY stage 4 moves in the horizontal direction in a state where the wiper 20 is disposed at the interference position, the wiper 20 scans the bottom surface of the well plate C to which the immersion liquid adheres. As a result, as illustrated in FIG. 14, the immersion liquid is wiped by the wiper 20 and falls from the bottom surface, and as illustrated in FIG. 15, the immersion liquid stored in a receiving portion 24 is guided to the drain tank through a pipe provided in the receiving portion 24.

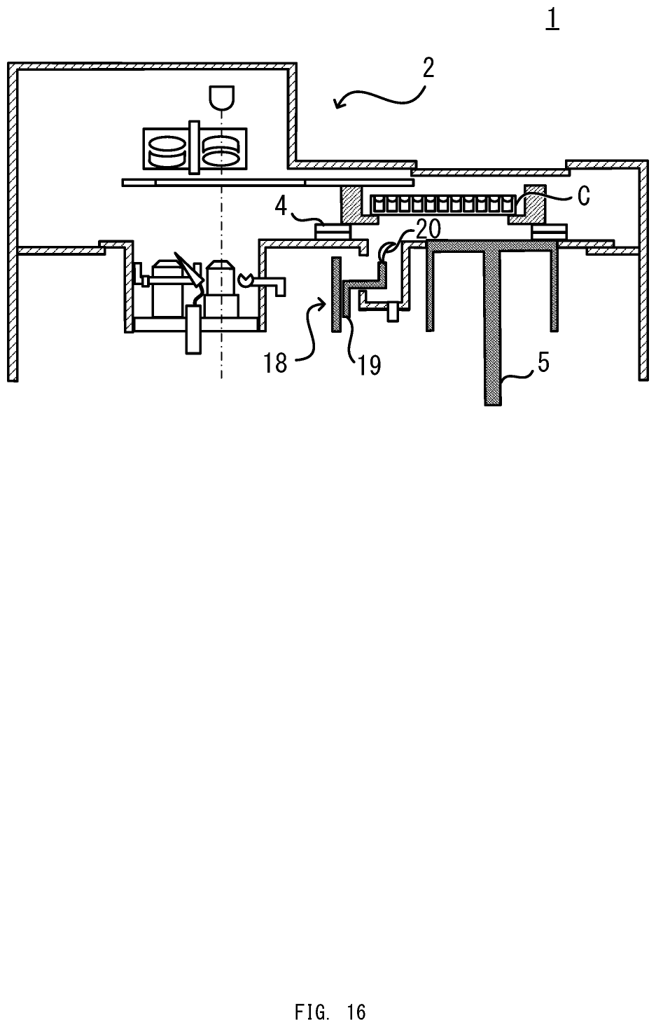

As illustrated in FIG. 15, when the wiper 20 reaches the end of the well plate C, the elevator 19 then is lowered, and as illustrated in FIG. 16, the wiper 20 moves to the retracted position where the wiper 20 is not in contact with the bottom surface of the well plate C.

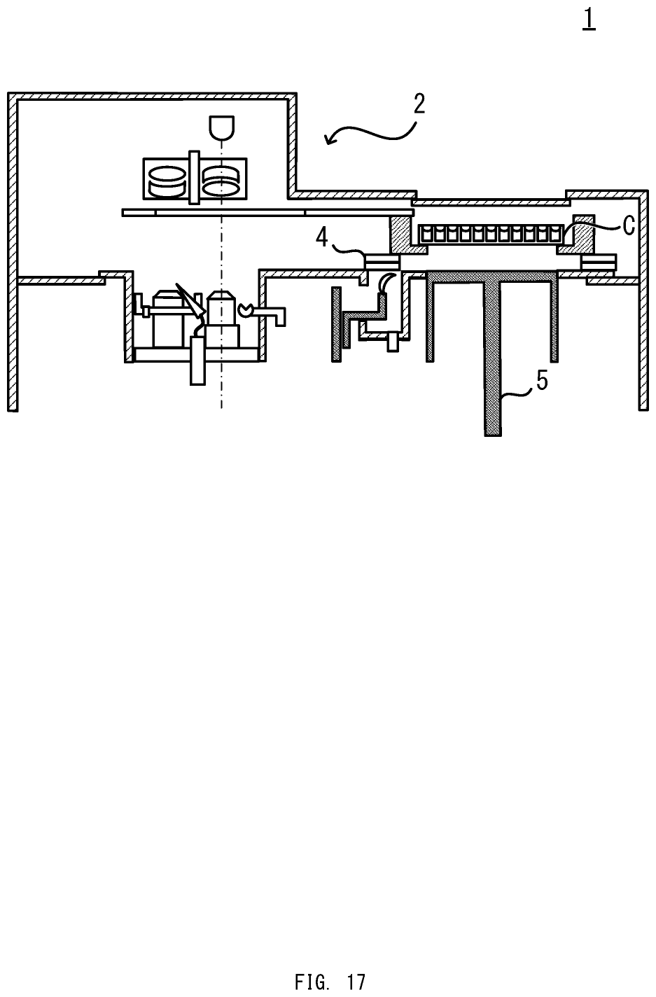

When the wiper 20 moves to the retracted position, the XY stage 4 starts to move toward the elevator 5 again, and then stops when the well plate C reaches the position above the elevator 5 as illustrated in FIG. 17.

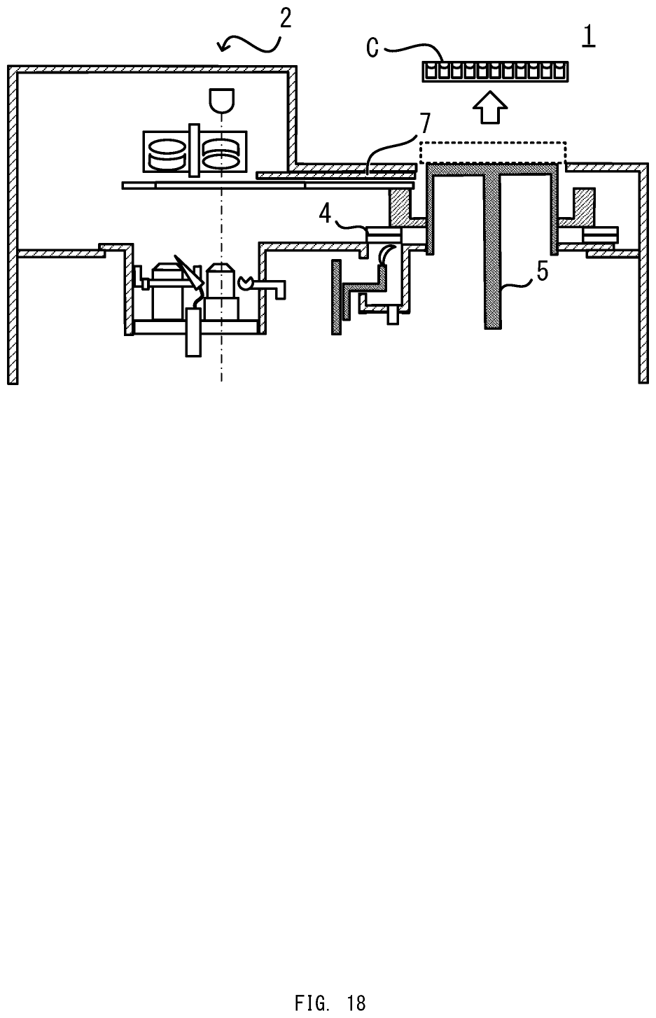

Finally, the open and close door 7 is opened, and the elevator 5 starts to rise. The elevator 5 receives the well plate C from the support portion 6a, lifts the well plate C to the delivery position, and then stops. Thereafter, as illustrated in FIG. 18, the well plate C is moved to the outside of the observation apparatus 1 by a user, a robot arm, or the like.

As described above, according to the observation apparatus 1, the bottom surface of the well plate C can be scanned by the wiper 20 while the well plate C moves from the observation position to the delivery position. Accordingly, it is possible to remove the immersion liquid adhering to the bottom surface of the well plate C to such an extent that droplets do not fall any further without sacrificing the throughput of the observation apparatus 1.

Furthermore, in the observation apparatus 1, the removal device 18 scans the bottom surface of the well plate C using the wiper 20 disposed at the interference position. As a result, according to the observation apparatus 1, the immersion liquid on the bottom surface of the well plate C can be sufficiently removed by pressing the wiper 20 against the well plate C with an appropriate pressing force. In addition, since the wiper 20 does not need to move to scan the bottom surface, the removal device 18 can be made compact. Therefore, according to the observation apparatus 1, it is possible to remove the immersion liquid on the bottom surface of the container while an increase in size of the device is avoided.

### Second Embodiment

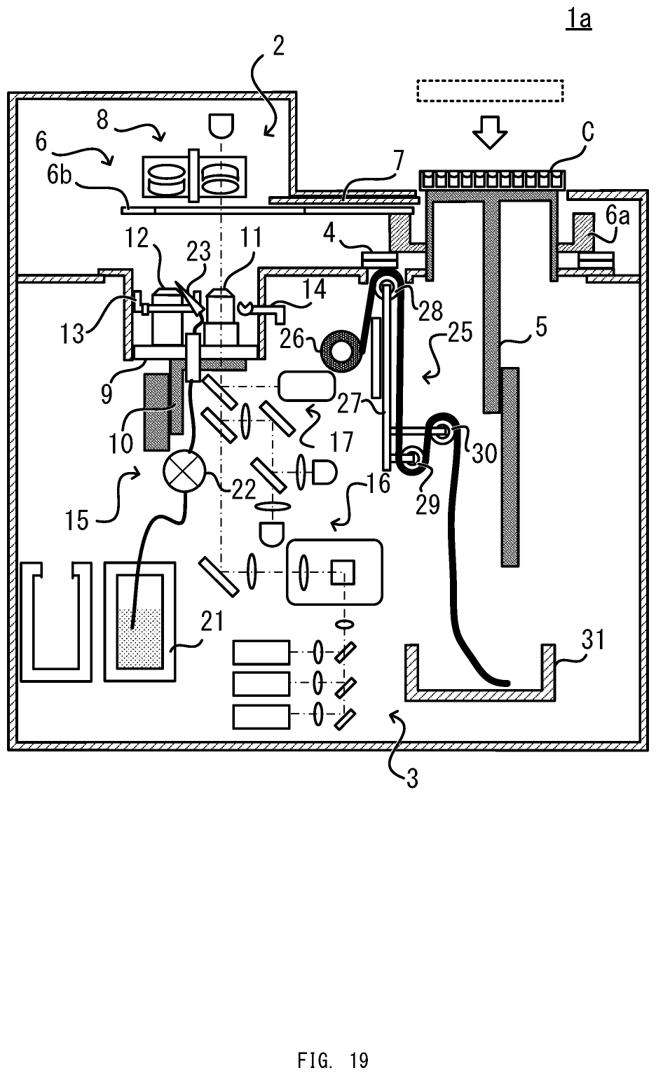

FIG. 19 is a diagram illustrating a configuration of an observation apparatus 1a according to this embodiment. Hereinafter, differences from the observation apparatus 1 according to the first embodiment in the configuration of the observation apparatus 1a will be described with reference to FIG. 19.

The observation apparatus 1a is an inverted microscope apparatus like the observation apparatus 1, and is an automatic microscope apparatus that automatically performs operations from conveyance of a container containing a sample to imaging of the sample contained in the container. The observation apparatus 1a is different from the observation apparatus 1 in that a removal device 25 is provided instead of the removal device 18.

The removal device 25 scans the bottom surface of the well plate C using the movement of an electric stage when the electric stage carries the well plate C from an observation position to a delivery position after imaging is completed. As a result, the immersion liquid adhering to the bottom surface of the well plate C is removed. In other words, the removal device 25 is a device that removes the immersion liquid adhering to the bottom surface of the well plate C placed on the XY stage 4, and is configured to scan the bottom surface of the well plate C using the movement of the XY stage 4. In this respect, the removal device 25 is similar to the removal device 18.

The removal device 25 includes the roll paper 26 that is a paper rolled in a roll, an elevator 27, a plurality of rollers (a roller 28, a roller 29, and a roller 30), and a paper ejector 31. The roll paper 26 is stretched around a plurality of rollers and extends to the paper ejector 31. The roll paper 26 is an example of an interference member that interferes with the immersion liquid adhering to the bottom surface of the well plate C during a period in which the XY stage 4 moves the well plate C from the observation position to the delivery position. Accordingly, the removal device 25 is similar to the removal device 18 in that the interference member is included. Furthermore, the roll paper 26 is similar to the wiper 20 that is the interference member included in the removal device 18 in that the roll paper 26 desirably has a width based on the size of the well plate C.

The roll paper 26 is an example of a liquid absorbing member, and is rolled in a roll. The roll paper 26 is disposed so as to absorb the immersion liquid moving together with the XY stage 4 at a predetermined position between the observation position and the delivery position. The roll paper 26 can efficiently absorb the immersion liquid adhering to the bottom surface by using a capillary phenomenon without applying an excessive pressure to the well plate C. In this respect, the removal device 25 differs from the removal device 18 that includes the wiper 20 disposed to block the immersion liquid at a predetermined position as the interference member.

The elevator 27 raises and lowers the roller 28, thereby moving the roll paper 26, which is the interference member, to an interference position and a retracted position. Furthermore, the elevator 27 specifies interference positions at different heights based on the well plate C on the basis of the information of the well plate C input to the observation apparatus 1a by a user before the start of the observation, and appropriately moves the roll paper 26 to the retracted position and the specified interference position. In this respect, the elevator 27 is similar to the elevator 19 of the removal device 18.

At least one (for example, the roller 30) of the plurality of rollers (the roller 28, the roller 29, and the roller 30) included in the removal device 25 is configured as a drive roller and functions as a winding device that winds the roll paper 26. The wound roll paper 26 is output to the paper ejector 31.

The drive roller desirably wind the roll paper 26 in accordance with the movement of the XY stage 4. As a result, since the portion of the roll paper 26 that has absorbed the immersion liquid on the bottom surface of the well plate C is wound in accordance with the movement of the well plate C, the portion of the roll paper 26 that has not absorbed the immersion liquid newly comes into contact with the bottom surface of the well plate C that reaches the interference position. Therefore, it is possible to avoid a situation in which the water absorption capacity of the roll paper 26 is insufficient and the immersion liquid on the bottom surface of the well plate C cannot be sufficiently absorbed.

By using the removal device 25, similarly to the observation apparatus 1, the observation apparatus 1a can remove the immersion liquid adhering to the bottom surface of the well plate C to such an extent that droplets do not fall any further using the conventionally performed operation of moving the well plate C from the observation position to the delivery position. Therefore, the observation apparatus 1a can also obtain effects similar to those of the observation apparatus 1.

In addition, since the observation apparatus 1a removes the immersion liquid using the capillary phenomenon of the roll paper 26, unlike the observation apparatus 1 that removes the immersion liquid by wiping the bottom surface of the well plate C with the wiper 20, there is no possibility that the bottom surface of the well plate C is damaged even in a case where observation is repeatedly performed. Therefore, according to the observation apparatus 1a, it is possible to avoid the degradation of optical performance due to scratches of the well plate C, and thus, it is possible to perform observation with stable performance even in a case where the observation is repeatedly performed.

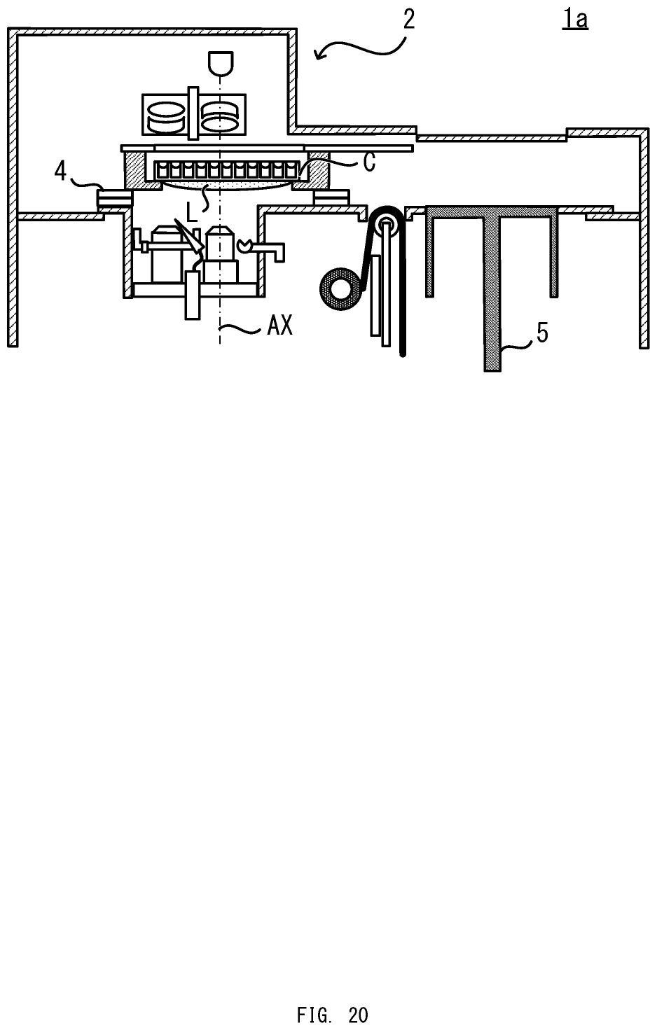

FIGS. 20 to 27 are diagrams for explaining an operation of the observation apparatus 1a. Hereinafter, the operation of the observation apparatus 1a after imaging at an observation position is completed will be described in detail with reference to FIGS. 20 to 27.

When the micro observation performed by filling the space between the objective 12 and the well plate C with the immersion liquid L is completed, the objective is moved in a direction away from the bottom surface of the well plate C by the focusing unit 10 (see FIG. 19) and is retracted. As a result, as illustrated in FIG. 20, the remaining immersion liquid L adheres to the bottom surface of the well plate C.

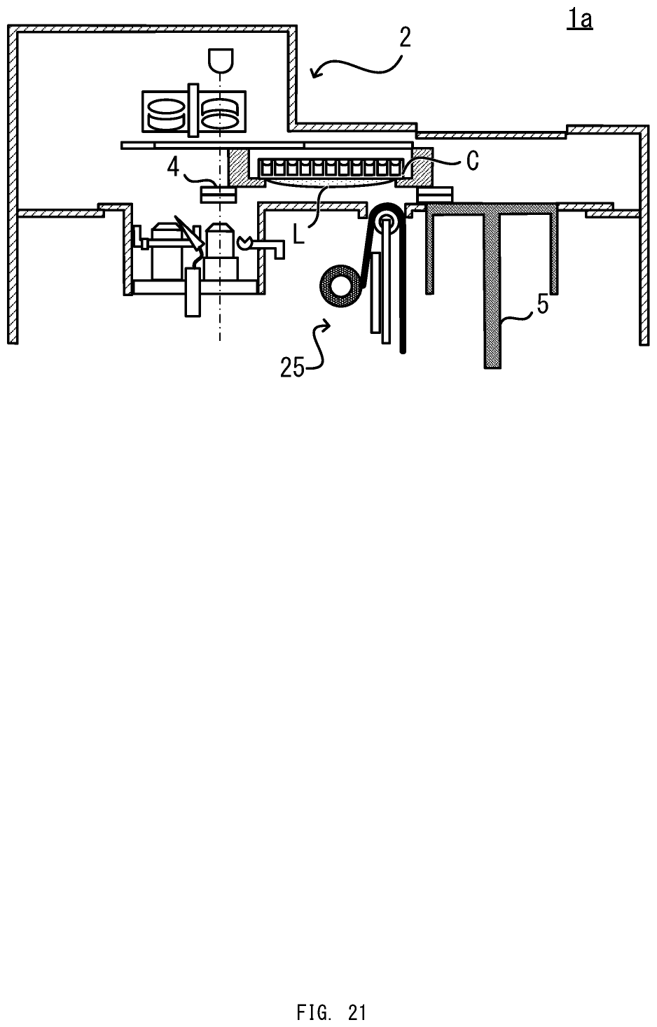

Thereafter, the XY stage 4 starts to move toward the elevator 5, and temporarily stops when the well plate C reaches the position above the removal device 25 as illustrated in FIG. 21.

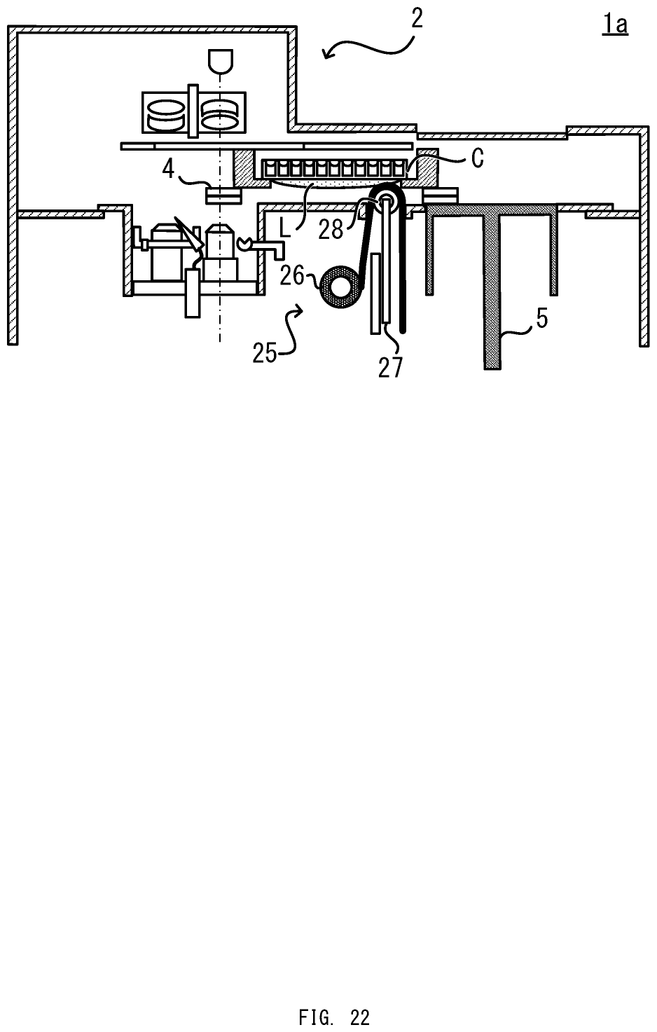

When the XY stage 4 stops, as illustrated in FIG. 22, the elevator 27 lifts the roller 28 to move the roll paper 26 on the upper surface of the roller 28 to the interference position where the roll paper 26 is in contact with the immersion liquid adhering to the bottom surface of the well plate C.

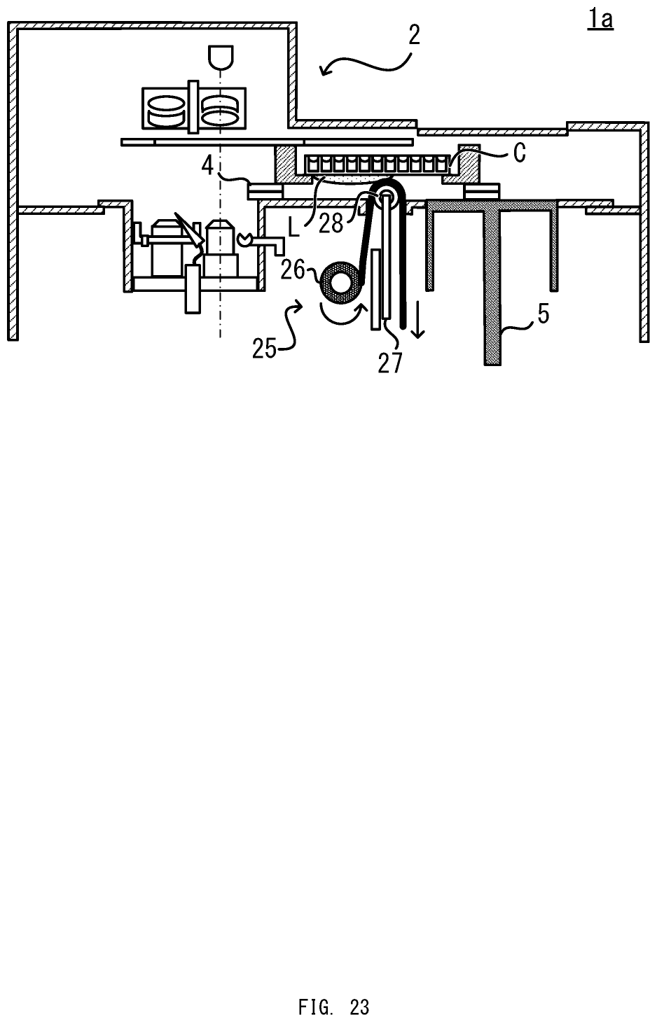

When the roll paper 26 is disposed at the interference position, the roll paper 26 starts to absorb the immersion liquid adhering to the bottom surface of the well plate C. Thereafter, as illustrated in FIG. 23, the XY stage 4 starts to move again in the horizontal direction toward the elevator 5. At this time, the roller 28 also starts to rotate in accordance with the amount of movement of the XY stage 4, and winds the roll paper 26 so that the amount of movement of the well plate C and the amount of conveyance of the roll paper 26 approximately match. As a result, the roll paper 26 that has absorbed the immersion liquid is discharged toward the paper ejector 31, and the immersion liquid on the bottom surface of the well plate C that has reached the interference position is absorbed by the newly unwound roll paper 26.

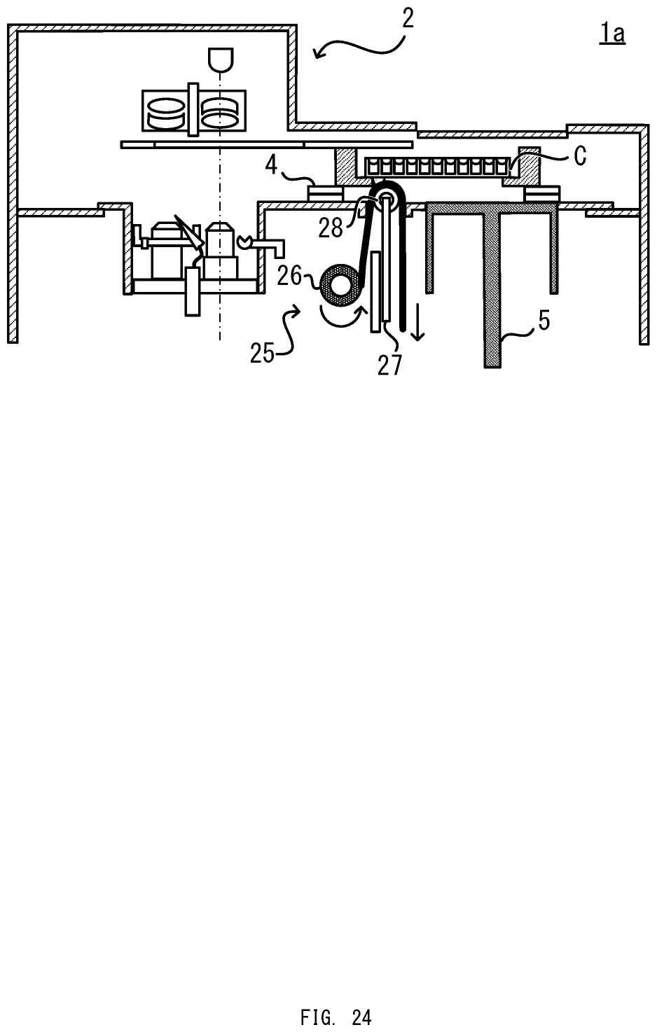

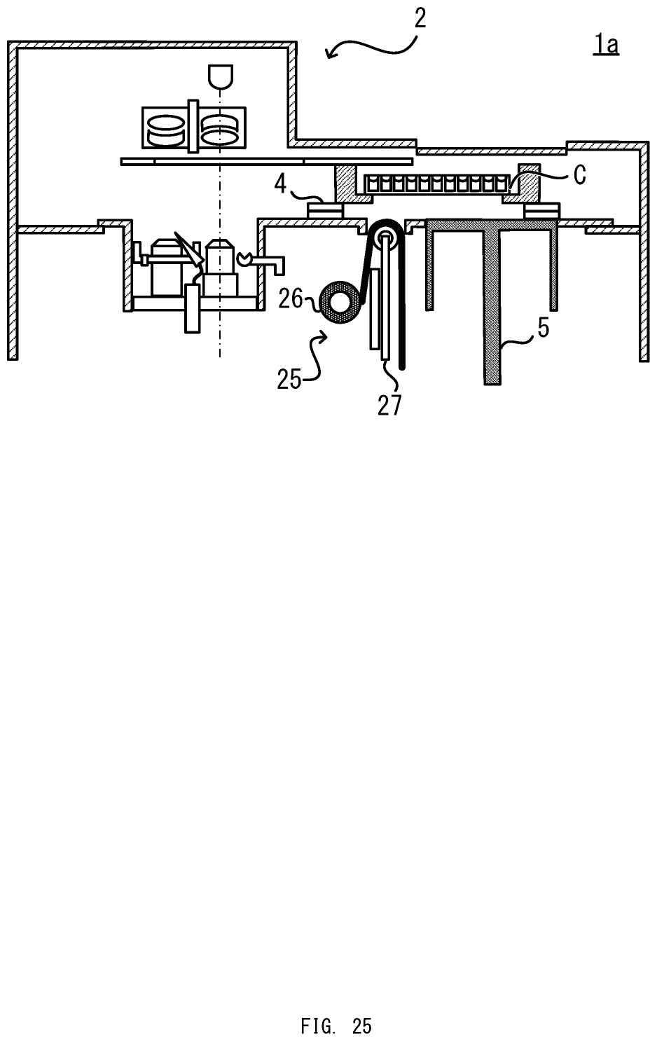

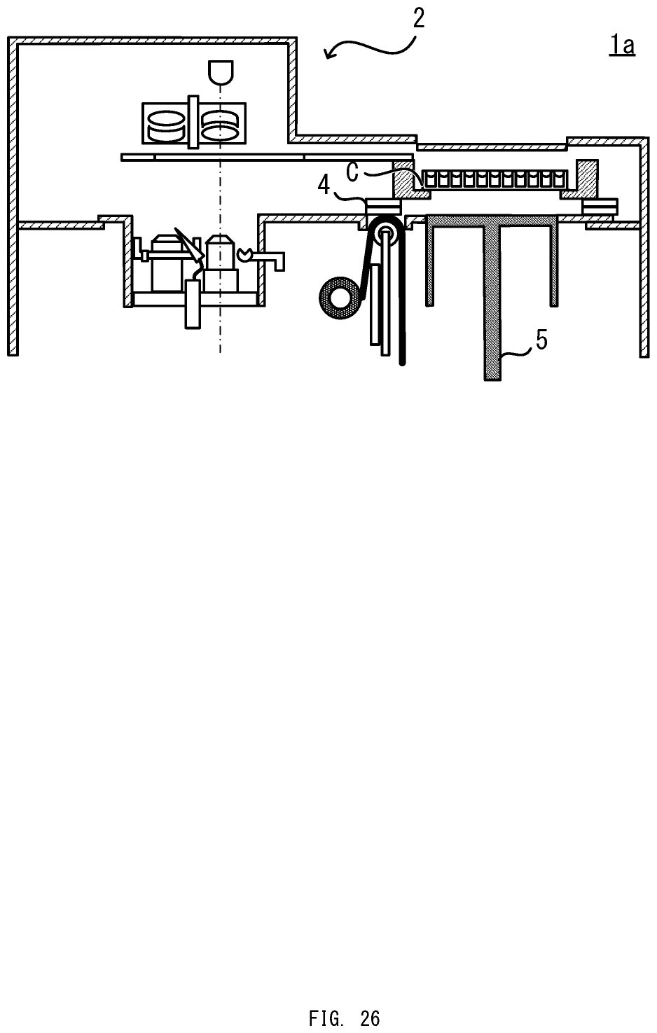

As illustrated in FIG. 24, when the roll paper 26 reaches the end of the well plate C, the elevator 27 is then lowered, and as illustrated in FIG. 25, the XY stage 4 moves again toward the elevator 5. Then, as illustrated in FIG. 26, when the well plate C reaches above the elevator 5, the XY stage 4 stops.

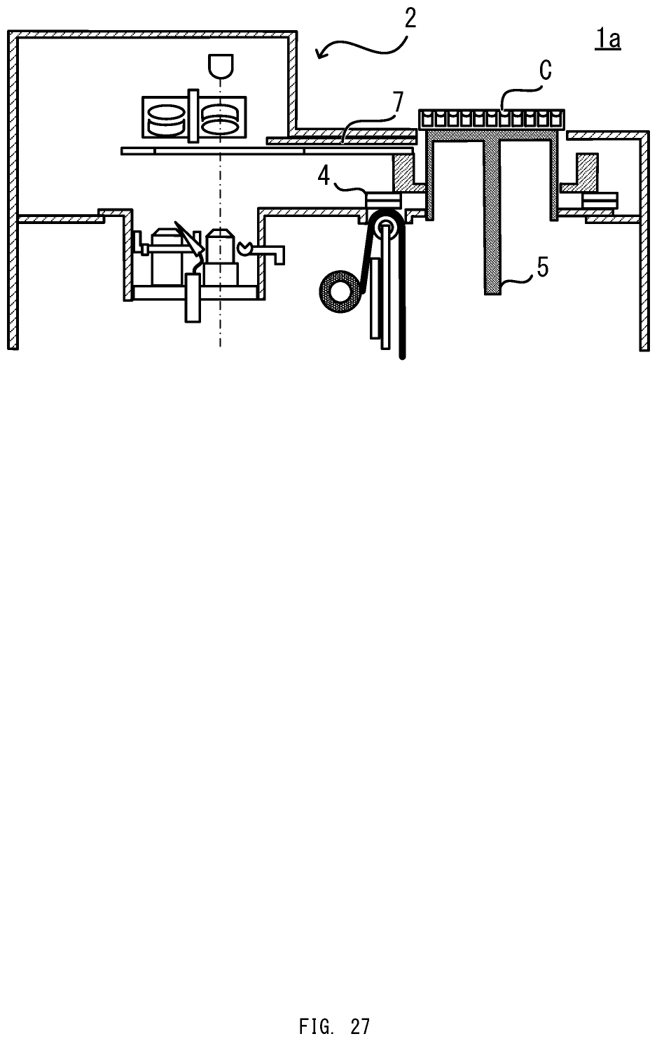

Finally, the open and close door 7 is opened, and the elevator 5 start to rise. The elevator 5 receives the well plate C from the support portion 6a, lifts the well plate C to the delivery position, and then stops. Thereafter, as illustrated in FIG. 27, the well plate C is moved to the outside of the observation apparatus 1a by a user, a robot arm, or the like.

As described above, according to the observation apparatus 1a, the bottom surface of the well plate C can be scanned by the roll paper 26 while the well plate C moves from the observation position to the delivery position. Accordingly, it is possible to remove the immersion liquid adhering to the bottom surface of the well plate C to such an extent that droplets do not fall any further without sacrificing the throughput of the observation apparatus 1a.

Furthermore, in the observation apparatus 1a, the removal device 25 scans the bottom surface of the well plate C using the roll paper 26 disposed at the interference position. As a result, according to the observation apparatus 1a, there is no possibility that the bottom surface of the well plate C is damaged when the immersion liquid is removed. Therefore, according to the observation apparatus 1a, even in a case where observation is repeatedly performed using the same well plate C, the observation can be performed with stable performance.

Note that the roll paper 26 is exemplified as the interference member in the observation apparatus 1a, but the interference member used in the observation apparatus 1a is not limited to the roll paper 26. Any member that absorbs the immersion liquid may be used, and for example, a towel or cloth may be used.

### Third Embodiment

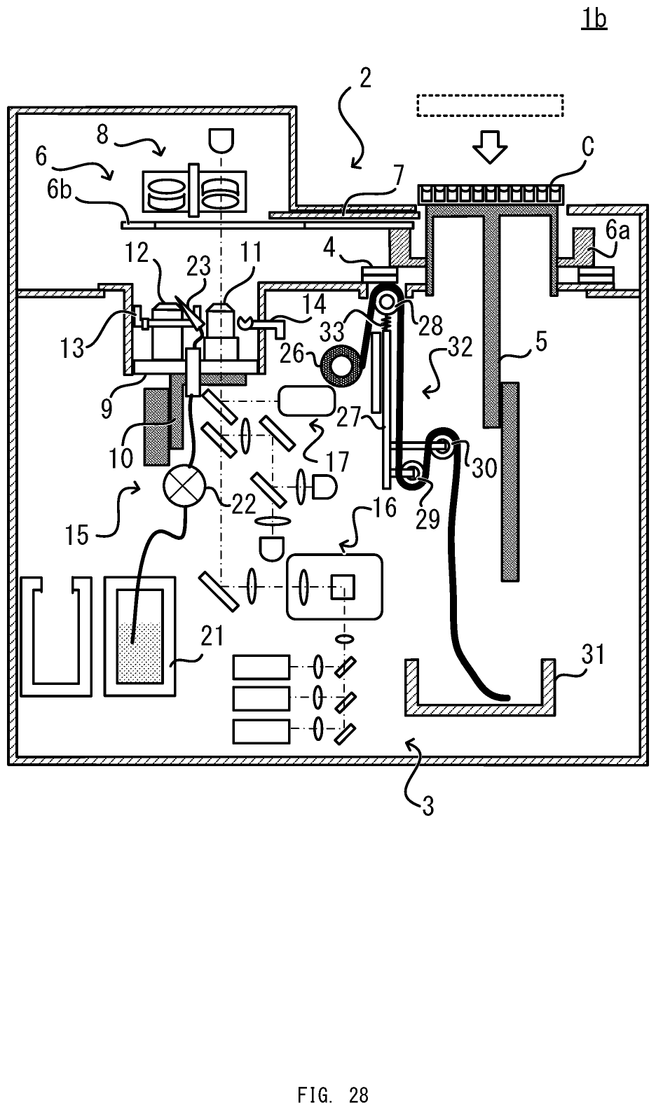

FIG. 28 is a diagram illustrating a configuration of an observation apparatus 1b according to this embodiment. Hereinafter, differences from the observation apparatus 1a according to the second embodiment in the configuration of the observation apparatus 1b will be described with reference to FIG. 28.

The observation apparatus 1b is an inverted microscope apparatus like the observation apparatus 1a, and is an automatic microscope apparatus that automatically performs operations from conveyance of a container containing a sample to imaging of the sample contained in the container. The observation apparatus 1b is different from the observation apparatus 1a in that a removal device 32 is provided instead of the removal device 25.

The removal device 32 is different from the removal device 25 in that the roller 28 is supported by a spring 33. In other respects, the removal device 32 is similar to the removal device 25. The second embodiment describes an example in which in view of the fact that the height of the bottom surface of the well plate C varies depending on the type and the manufacturer of the well plate C, or the like, the interference position based on the well plate C is specified on the basis of the information of the well plate C. However, in this embodiment, the control process of specifying such an interference position may be omitted. According to the observation apparatus 1b, since the difference in height of the bottom surface of the well plate C can be absorbed by the expansion and contraction of the spring 33, the process of actively controlling the interference position based on the well plate C can be omitted.

Note that the roll paper 26 is thinner than the wiper 20 or the like, and thus the roller 28 easily collides with the well plate C via the roll paper 26 due to a slight difference in height of the bottom surface of the well plate C. Therefore, similarly to the observation apparatus 1b, the observation apparatus 1c may also perform the process of actively controlling the interference position based on the well plate C. By performing the process of actively controlling the interference position based on the well plate C and further supporting the roller 28 by the spring 33, it is possible to more reliably avoid a situation in which an excessive pressure is applied to the well plate C.

### Fourth Embodiment

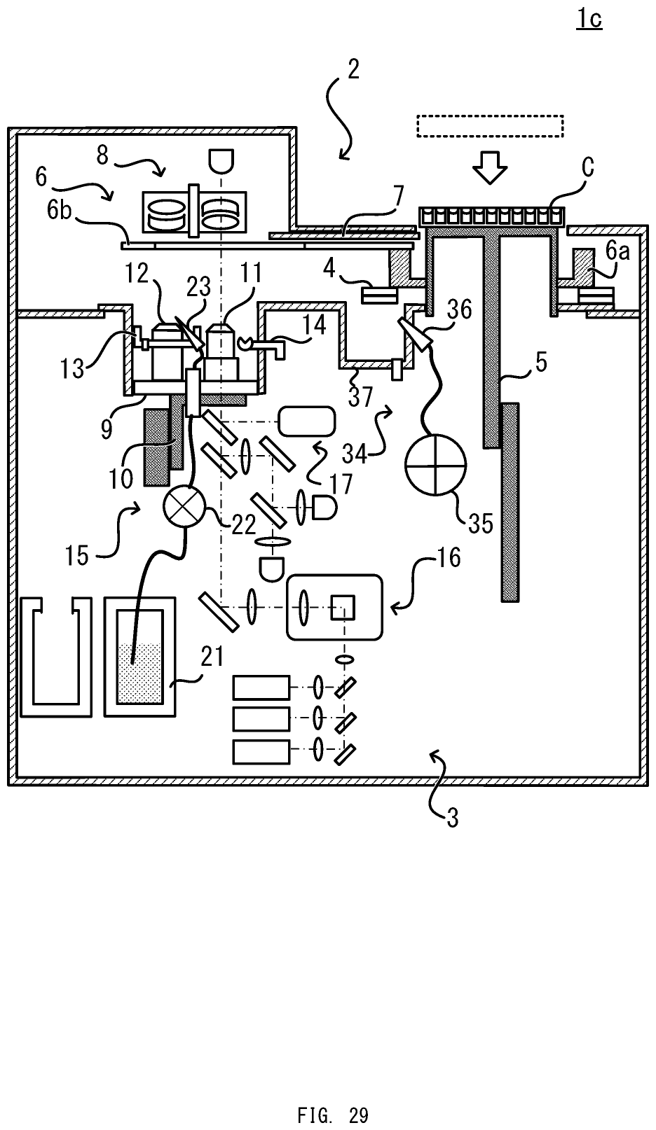

FIG. 29 is a diagram illustrating a configuration of an observation apparatus 1c according to this embodiment. Hereinafter, differences from the observation apparatus 1 according to the first embodiment in the configuration of the observation apparatus 1c will be described with reference to FIG. 29.

The observation apparatus 1c is an inverted microscope apparatus like the observation apparatus 1, and is an automatic microscope apparatus that automatically performs operations from conveyance of a container containing a sample to imaging of the sample contained in the container. The observation apparatus 1c is different from the observation apparatus 1 in that a removal device 34 is provided instead of the removal device 18.

The removal device 34 scans the bottom surface of the well plate C using the movement of an electric stage when the electric stage carries the well plate C from an observation position to a delivery position after imaging is completed. As a result, the immersion liquid adhering to the bottom surface of the well plate C is removed. In other words, the removal device 34 is a device that removes the immersion liquid adhering to the bottom surface of the well plate C placed on the XY stage 4, and is configured to scan the bottom surface of the well plate C using the movement of the XY stage 4. In this respect, the removal device 34 is similar to the removal device 18.

The removal device 34 includes a blower 35. The blower 35 blows a gas to the immersion liquid adhering to the bottom surface of the well plate C during a period in which the XY stage 4 moves the well plate C from the observation position to the delivery position. The removal device 34 blows the gas ejected from a nozzle 36 of the blower 35 to the bottom surface of the well plate C being conveyed by the XY stage 4 to blow off and remove the immersion liquid adhering to the bottom surface of the well plate C. The blown immersion liquid is collected in a drain bottle through a pipe provided in a receiving portion 37.

The blower 35 is, for example, a compressor, but may be a blower with a pressure lower than that of a compressor such as a fan or a blower as long as the immersion liquid can be removed. The nozzle 36 constituting the ejection port of the blower 35 has a width based on the size of the well plate C, and the removal device 34 scans the bottom surface of the well plate C with the gas ejected from the ejection port using the movement of the XY stage 4 in a direction orthogonal to the optical axis of the objective 12 and intersecting the direction of the width of the nozzle 36. As a result, since the entire bottom surface of the well plate C is scanned with the gas, the immersion liquid adhering to the bottom surface of the well plate C can be sufficiently removed.

Furthermore, the nozzle 36 is fixed while being oriented in a predetermined direction. The direction of the nozzle 36 is desirably determined in advance and fixed so that the airflow of the gas ejected from the nozzle 36 includes at least a vector component opposite to the moving direction of the well plate C from the observation position to the delivery position. As a result, it is possible to efficiently remove the immersion liquid on the bottom surface of the well plate C using the force of movement of the well plate C.

By using the removal device 34, similarly to the observation apparatus 1, the observation apparatus 1c can remove the immersion liquid adhering to the bottom surface of the well plate C to such an extent that droplets do not fall any further using the conventionally performed operation of moving the well plate C from the observation position to the delivery position. Therefore, the observation apparatus 1c can also obtain effects similar to those of the observation apparatus 1.

Although the example in which the nozzle 36 is fixed has been described above, a structure of adjusting the position of the nozzle 36 based on the well plate C may be provided, and an optimum airflow based on the well plate C may be blown to the bottom surface of the well plate C. Alternatively, the flow rate of the gas ejected from the blower 35 may be controlled based on the well plate C while the nozzle 36 is fixed.

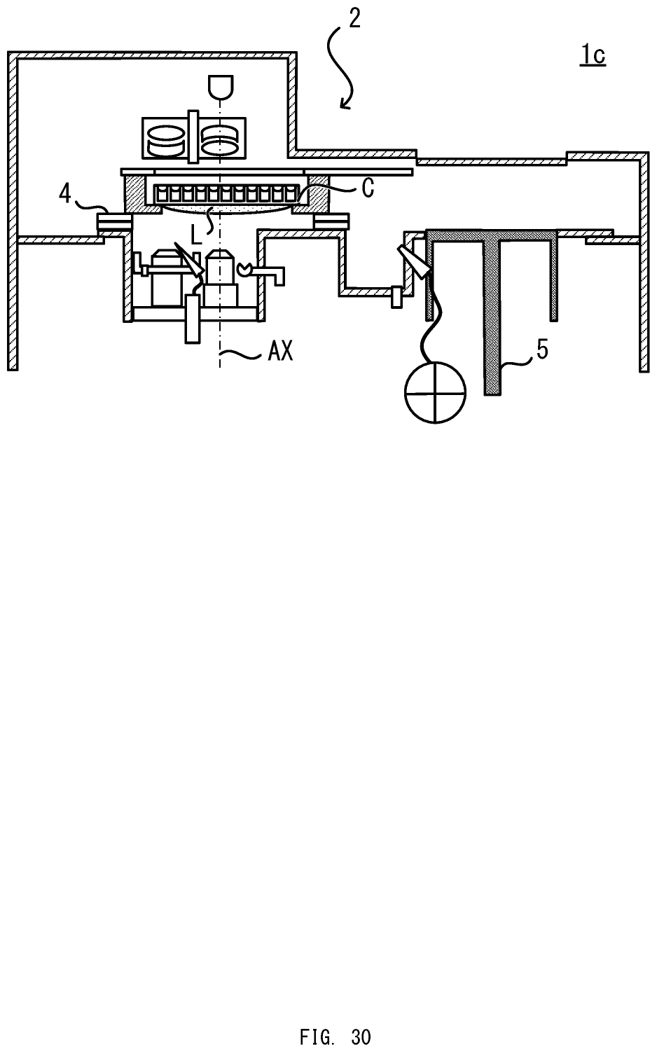

FIGS. 30 to 33 are diagrams for explaining an operation of the observation apparatus 1c. Hereinafter, the operation of the observation apparatus 1c after imaging at an observation position is completed will be described in detail with reference to FIGS. 30 to 33.

When the micro observation performed by filling the space between the objective 12 and the well plate C with the immersion liquid L is completed, the objective is moved in a direction away from the bottom surface of the well plate C by the focusing unit 10 (see FIG. 29) and is retracted. As a result, as illustrated in FIG. 30, the remaining immersion liquid L adheres to the bottom surface of the well plate C.

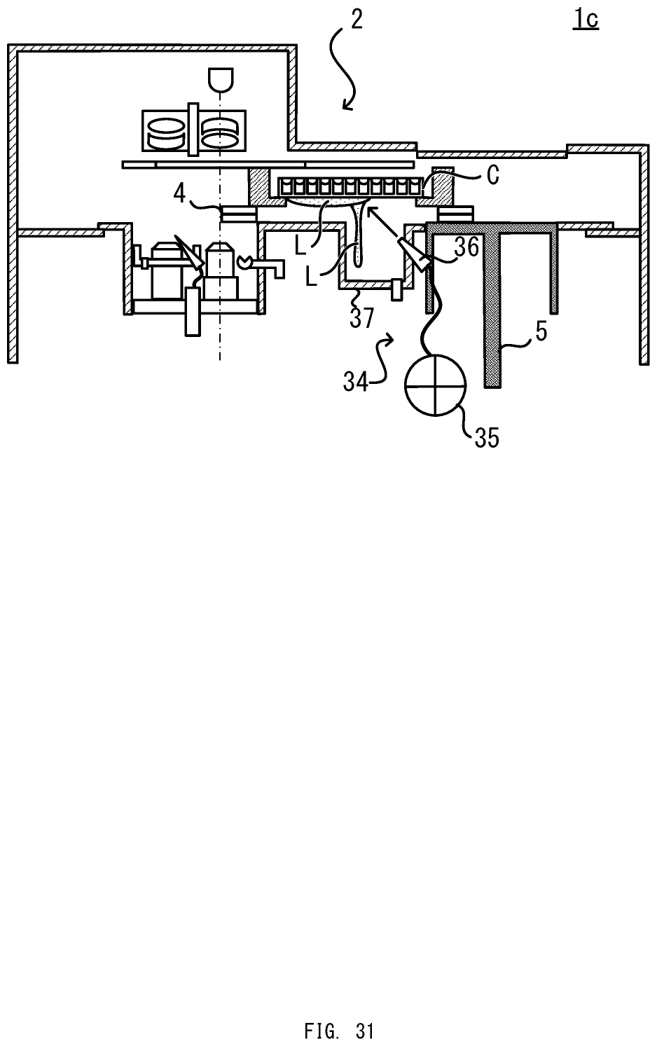

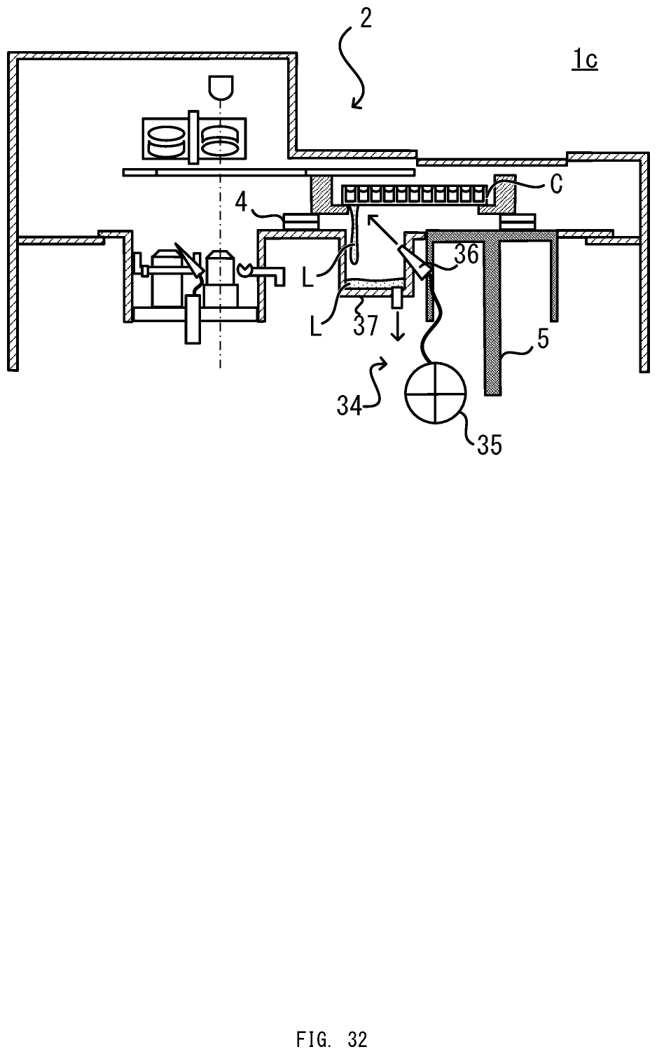

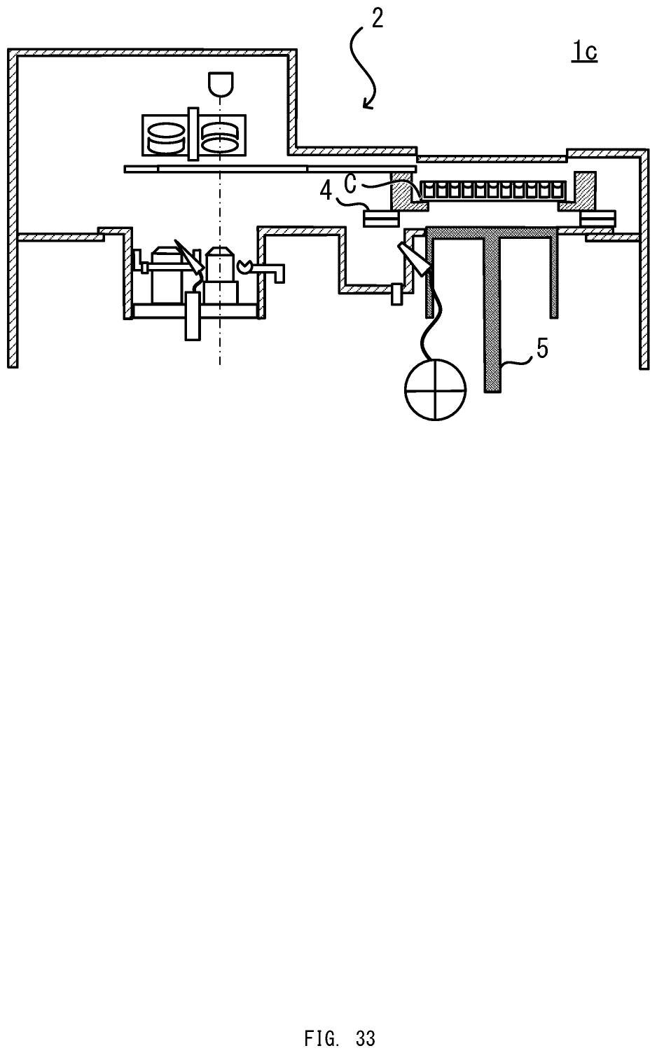

Thereafter, the blower 35 starts to supply air at the same time as the XY stage 4 starts to move toward the elevator 5. As a result, as illustrated in FIG. 31, the gas ejected from the nozzle 36 gradually removes the immersion liquid adhering to the bottom surface of the well plate C from the bottom surface, and as illustrated in FIG. 32, the immersion liquid is finally removed from the entire bottom surface of the well plate C. Thereafter, the blower 35 stops supplying air. The XY stage 4 continues to move the well plate C toward the elevator 5, and as illustrated in FIG. 33, when the well plate C reaches the position above the elevator 5, the XY stage 4 stops.

Finally, the open and close door 7 is opened, and the elevator 5 start to rise. The elevator 5 receives the well plate C from the support portion 6a, lifts the well plate C to the delivery position, and then stops. Thereafter, the well plate C is moved to the outside of the observation apparatus 1c by a user, a robot arm, or the like.

As described above, according to the observation apparatus 1c, the bottom surface of the well plate C can be scanned by the gas while the well plate C moves from the observation position to the delivery position. Accordingly, it is possible to remove the immersion liquid adhering to the bottom surface of the well plate C to such an extent that droplets do not fall any further without sacrificing the throughput of the observation apparatus 1c.

In addition, the observation apparatus 1c removes the immersion liquid by blowing off the immersion liquid with the gas, and thus there is no possibility that the bottom surface of the well plate C is damaged upon removal of the immersion liquid, similarly to the observation apparatus 1a and the observation apparatus 1b. Therefore, according to the observation apparatus 1c, even in a case where observation is repeatedly performed using the same well plate C, the observation can be performed with stable performance.

### Fifth Embodiment

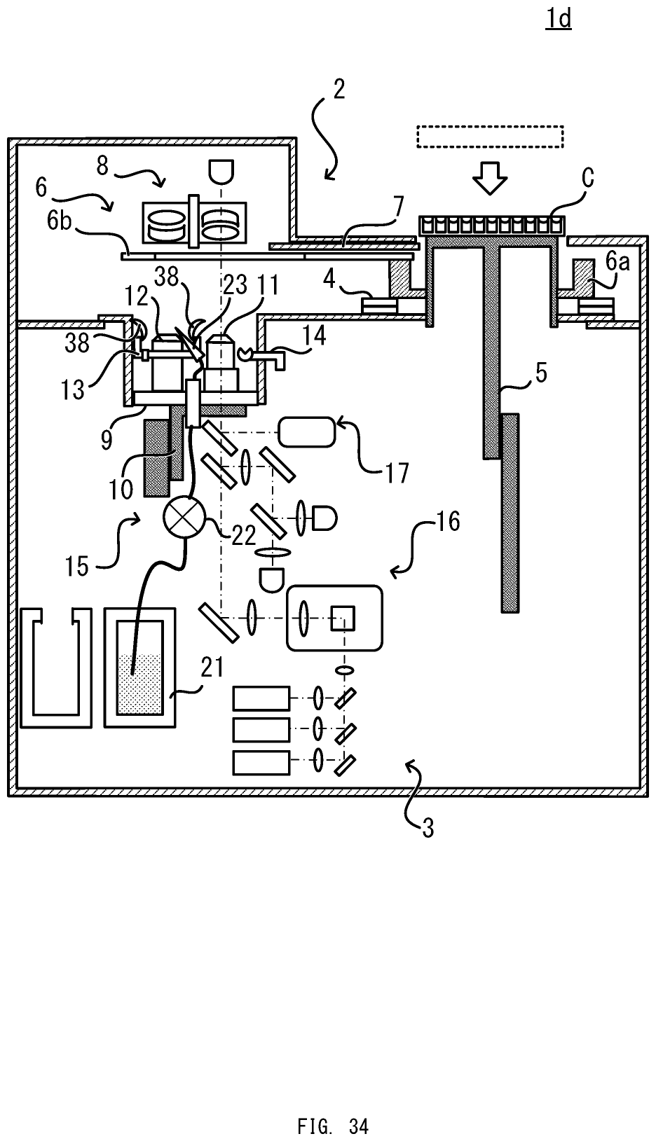

FIG. 34 is a diagram illustrating a configuration of an observation apparatus 1d according to this embodiment. Hereinafter, differences from the observation apparatus 1 according to the first embodiment in the configuration of the observation apparatus 1d will be described with reference to FIG. 34.

The observation apparatus 1d is an inverted microscope apparatus like the observation apparatus 1, and is an automatic microscope apparatus that automatically performs operations from conveyance of a container containing a sample to imaging of the sample contained in the container. The observation apparatus 1d is different from the observation apparatus 1 in that the observation apparatus 1d includes a wiper 38 attached to the adapter 13 instead of the removal device 18. In addition, the observation apparatus 1d is different from the observation apparatus 1 in that the immersion liquid adhering to the bottom surface of the well plate C is removed using the wiper 38 when the XY stage 4 is moved to change a well to be observed.

The wiper 38 is an interference member corresponding to the wiper 20 of the removal device 18, and interferes with the immersion liquid adhering to the bottom surface of the well plate C. The wiper 38 is disposed so as to be in contact with the bottom surface of the well plate C during the micro observation using the objective 12. Further, the wiper 38 is attached to the objective 12 via the adapter 13 so as to block the movement of the immersion liquid moving together with the XY stage 4. That is, in the observation apparatus 1d, the adapter 13 to which the wiper 38 is attached corresponds to a removal device.

Note that although FIG. 34 illustrates an example in which the two wipers 38 are attached to the adapter 13 at positions symmetrical to each other with respect to the optical axis of the objective 12, the number and arrangement of the wipers 38 are not limited to this example. The XY stage 4 moves in various directions to change the well to be observed. If the immersion liquid can be removed even during the movement for changing the well to be observed, most of the immersion liquid adhering to the bottom surface of the well plate C can be removed. Therefore, the wiper 38 may be disposed in various directions in which the XY stage 4 may move. Furthermore, the wiper 38 may have an annular shape surrounding the objective 12. By providing the wiper 38 with an annular shape, the immersion liquid can be removed regardless of the moving direction of the XY stage 4.

The observation apparatus 1d configured as described above can also remove the immersion liquid adhering to the bottom surface of the well plate C using the conventionally performed operation to change the well to be observed. Therefore, the observation apparatus 1d can also obtain effect similar to those of the observation apparatus 1.

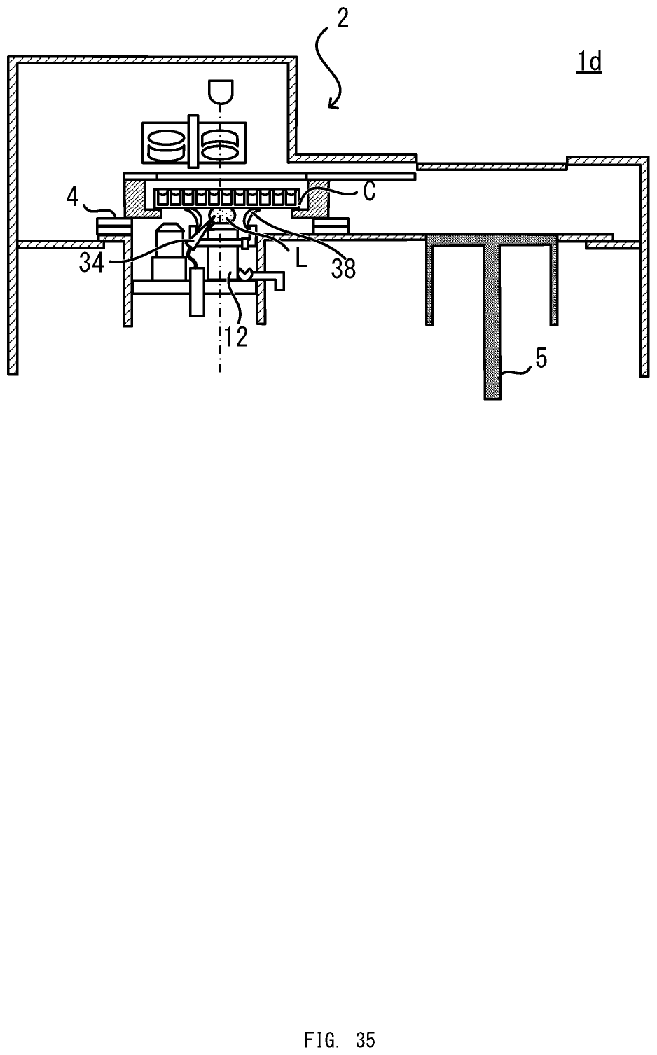

FIGS. 35 to 37 are diagrams for explaining an operation of the observation apparatus 1d. Hereinafter, the operation of the observation apparatus 1d after imaging at an observation position is completed will be described in detail with reference to FIGS. 35 to 37.

FIG. 35 illustrates a state where the micro observation of a predetermined well that is performed while the space between the objective 12 and the bottom surface of the well plate C is filled with the immersion liquid L is completed. At this time, the wipers 38 are in contact with the bottom surface of the well plate C.

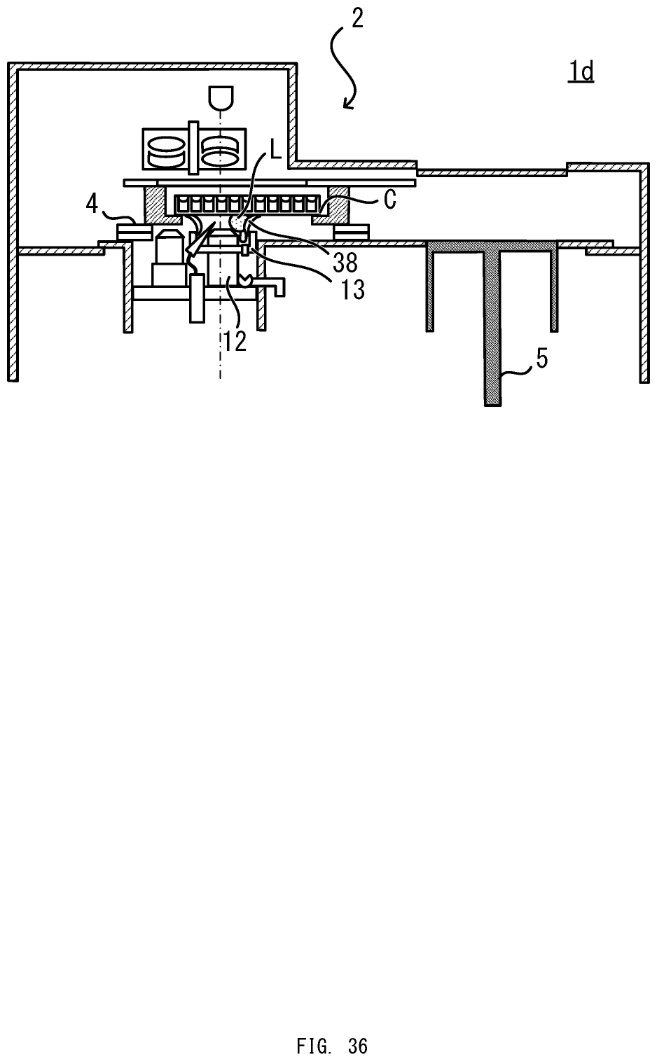

Thereafter, in a case where the XY stage 4 is moved to the position of the micro observation of the next well, the XY stage 4 is moved without retracting the objective 12. Therefore, as illustrated in FIG. 36, the movement of the immersion liquid L adhering to and moving on the bottom surface of the well plate C together with the XY stage 4 is blocked by the wipers 38 interfering with the bottom surface of the well plate C.

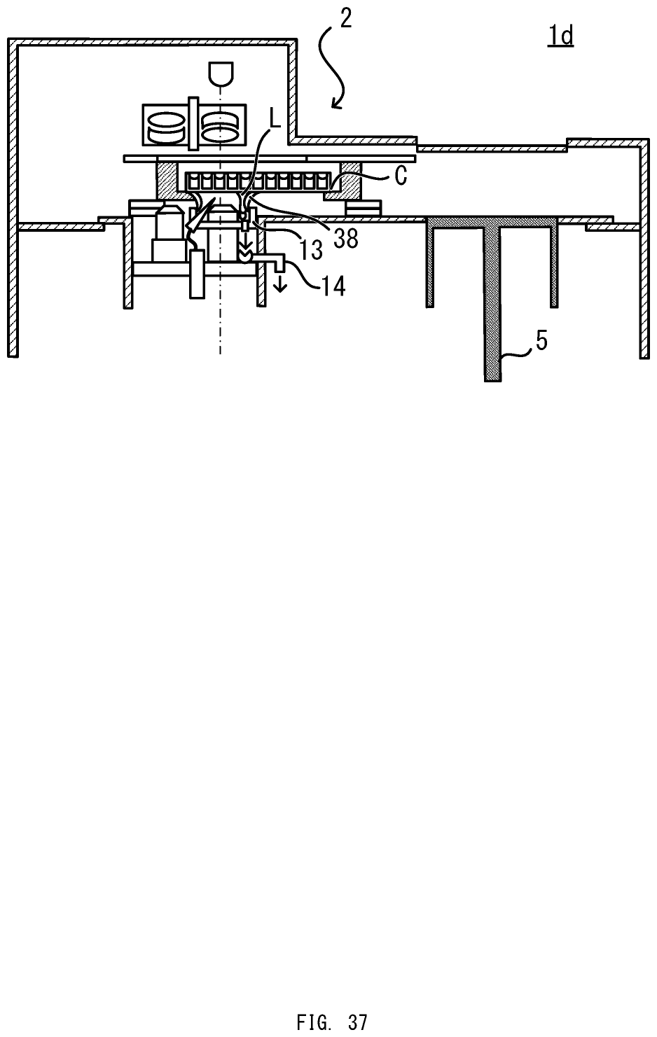

As a result, as illustrated in FIG. 37, the immersion liquid L blocked by the wipers 38 falls from the bottom surface of the well plate C and is guided to a drain bottle through a pipe provided in the adapter 13 and the receiving portion 14.

As described above, according to the observation apparatus 1d, the bottom surface of the well plate C can be scanned by the wiper 38 while the XY stage 4 is moved to change the well to be observed. Accordingly, it is possible to remove the immersion liquid adhering to the bottom surface of the well plate C without sacrificing the throughput of the observation apparatus 1d.

Note that, in the observation apparatus 1d, an example in which the wipers 38 come into contact with the well plate C has been described. However, similarly to the wiper 20 of the observation apparatus 1, the wipers 38 are only required to interfere with the immersion liquid adhering to the bottom surface of the well plate C, and the wipers 38 do not necessarily come into contact with the bottom surface of the well plate C. The wipers 38 may be attached to the adapter 13 so that a slight gap is formed between the wipers 38 and the bottom surface.

The above embodiments are specific examples for facilitating the understanding of the invention, and the present invention is not limited to these embodiments. Modifications obtained by modifying the above embodiments and alternative forms replacing the above embodiments can be included. That is, in each embodiment, the constituent elements can be modified without departing from the spirit and the scope thereof. Further, a new embodiment can be implemented by appropriately combining the multiple constituent elements disclosed in one or more of the embodiments. Further, some constituent elements may be omitted from the constituent elements described in the corresponding embodiment, or some constituent elements may be added to the constituent elements described in the embodiment. Further, the order of the processing procedures in each embodiment is interchangeable as long as there is no contradiction. That is, the inverted microscope apparatus of the present invention can be variously modified and changed without departing from the scope of the invention defined by the claims.

For example, the observation apparatus may be configured to include both the removal device 18 of the observation apparatus 1 and the wiper 38 of the observation apparatus 1d. As a result, the observation apparatus can remove the immersion liquid both during the movement between the wells and during the movement from the observation position to the delivery position.

What is claimed is:

1. An inverted microscope apparatus comprising:
an immersion objective;
an electric stage that moves at least in a direction orthogonal to an optical axis of the immersion objective; and
a removal mechanism that removes an immersion liquid adhering to a bottom surface of a container placed on the electric stage, wherein
the removal mechanism is configured to scan the bottom surface using movement of the electric stage.

2. The inverted microscope apparatus according to claim 1, wherein
the removal mechanism includes an interference member that interferes with an immersion liquid, and
the interference member interferes with the immersion liquid adhering to the bottom surface of the container during a period in which the electric stage moves the container from an observation position on the optical axis of the immersion objective to a delivery position for placing the container on the inverted microscope apparatus.

3. The inverted microscope apparatus according to claim 2, wherein
the removal mechanism includes a wiper as the interference member, and
the wiper is disposed so as to block movement of the immersion liquid moving together with the electric stage at a predetermined position between the observation position and the delivery position.

4. The inverted microscope apparatus according to claim 2, wherein
the removal mechanism includes a liquid absorbing member as the interference member, and
the liquid absorbing member is disposed so as to absorb the immersion liquid moving together with the electric stage at a predetermined position between the observation position and the delivery position.

5. The inverted microscope apparatus according to claim 4, wherein
the liquid absorbing member is wound in a roll,
the removal mechanism further includes a winding device that winds the liquid absorbing member, and
the winding device winds the liquid absorbing member in accordance with movement of the electric stage.

6. The inverted microscope apparatus according to claim 2, wherein
the removal mechanism includes a moving device that moves the interference member, the moving device is configured to hold the interference member at the interference position during a period in which the electric stage moves the container from the observation position to the delivery position and at least the container passes through the interference position, and
hold the interference member at a retracted position during a period in which the electric stage moves the container from the delivery position to the observation position.

7. The inverted microscope apparatus according to claim 3, wherein
the removal mechanism includes a moving device that moves the interference member,
the moving device is configured to
hold the interference member at the interference position during a period in which the electric stage moves the container from the observation position to the delivery position and at least the container passes through the interference position, and
hold the interference member at a retracted position during a period in which the electric stage moves the container from the delivery position to the observation position.

8. The inverted microscope apparatus according to claim 4, wherein
the removal mechanism includes a moving device that moves the interference member,
the moving device is configured to
hold the interference member at the interference position during a period in which the electric stage moves the container from the observation position to the delivery position and at least the container passes through the interference position, and
hold the interference member at a retracted position during a period in which the electric stage moves the container from the delivery position to the observation position.

9. The inverted microscope apparatus according to claim 5, wherein
the removal mechanism includes a moving device that moves the interference member,
the moving device is configured to
hold the interference member at the interference position during a period in which the electric stage moves the container from the observation position to the delivery position and at least the container passes through the interference position, and
hold the interference member at a retracted position during a period in which the electric stage moves the container from the delivery position to the observation position.

10. The inverted microscope apparatus according to claim 1, wherein
the removal mechanism includes a wiper as an interference member that interferes with the immersion liquid adhering to the bottom surface of the container, and
the wiper is attached to the immersion objective to block movement of the immersion liquid moving together with the electric stage.

11. The inverted microscope apparatus according to claim 2, wherein
the interference member has a width based on a size of the container, and
the removal mechanism scans the bottom surface with the interference member using movement of the electric stage in a direction orthogonal to the optical axis of the immersion objective and intersecting a direction of the width.

12. The inverted microscope apparatus according to claim 3, wherein
the interference member has a width based on a size of the container, and
the removal mechanism scans the bottom surface with the interference member using movement of the electric stage in a direction orthogonal to the optical axis of the immersion objective and intersecting a direction of the width.

13. The inverted microscope apparatus according to claim 4, wherein
the interference member has a width based on a size of the container, and
the removal mechanism scans the bottom surface with the interference member using movement of the electric stage in a direction orthogonal to the optical axis of the immersion objective and intersecting a direction of the width.

14. The inverted microscope apparatus according to claim 5, wherein
the interference member has a width based on a size of the container, and
the removal mechanism scans the bottom surface with the interference member using movement of the electric stage in a direction orthogonal to the optical axis of the immersion objective and intersecting a direction of the width.

15. The inverted microscope apparatus according to claim 6, wherein
the interference member has a width based on a size of the container, and
the removal mechanism scans the bottom surface with the interference member using movement of the electric stage in a direction orthogonal to the optical axis of the immersion objective and intersecting a direction of the width.

16. The inverted microscope apparatus according to claim 7, wherein
the interference member has a width based on a size of the container, and
the removal mechanism scans the bottom surface with the interference member using movement of the electric stage in a direction orthogonal to the optical axis of the immersion objective and intersecting a direction of the width.

17. The inverted microscope apparatus according to claim 8, wherein
the interference member has a width based on a size of the container, and
the removal mechanism scans the bottom surface with the interference member using movement of the electric stage in a direction orthogonal to the optical axis of the immersion objective and intersecting a direction of the width.

18. The inverted microscope apparatus according to claim 9, wherein
the interference member has a width based on a size of the container, and
the removal mechanism scans the bottom surface with the interference member using movement of the electric stage in a direction orthogonal to the optical axis of the immersion objective and intersecting a direction of the width.

19. The inverted microscope apparatus according to claim 1, wherein
the removal mechanism includes a blower, and
the blower blows a gas to an immersion liquid adhering to the bottom surface of the container during a period in which the electric stage moves the container from an observation position on the optical axis of the immersion objective to a delivery position for placing the container on the inverted microscope apparatus.

20. The inverted microscope apparatus according to claim 19, wherein
an ejection port of the blower has a width based on a size of the container, and
the removal mechanism scans the bottom surface by a gas ejected from the ejection port of the blower using movement of the electric stage in a direction orthogonal to the optical axis of the immersion objective and intersecting a direction of the width.
